(19) United States
(12) Patent Application Publication
(10) Pub. No.: US 2022/0342329 A1
(43) Pub. Date: Oct. 27, 2022

(54) TONER AND METHOD FOR PRODUCING TONER

(71) Applicant: CANON KABUSHIKI KAISHA, Tokyo (JP)

(72) Inventors: Yuna Yamamoto, Tokyo (JP); Takashi Matsui, Shizuoka (JP); Kenji Aoki, Shizuoka (JP); Yu Yoshida, Shizuoka (JP)

(21) Appl. No.: 17/658,352

(22) Filed: Apr. 7, 2022

(30) Foreign Application Priority Data
Apr. 14, 2021 (JP) 2021-068154
Mar. 16, 2022 (JP) 2022-041315

(51) Int. Cl. G03G 9/087; G03G 9/08; C08F 212/10

(52) U.S. Cl. CPC G03G 9/08731; G03G 9/0806; C08F 212/10

(57) ABSTRACT

A toner comprising a toner particle comprising a binder resin, wherein the binder resin comprises a resin A and a resin B, in a differential scanning calorimetric measurement, a peak top temperature of the largest endothermic peak is present within a specific temperature range and an endothermic amount of an endothermic peak derived from the resin A is 30 to 70 J/g per 1 g of the toner, a ratio of content of the resin A in the toner particle is 60.0 to 90.0 mass %, the resin A comprises 40.0 to 70.0 mass % of a monomer unit (a) represented by formula (1) below, and the resin B comprises 5.0 to 30.0 mass % of a monomer unit (b) represented by formula (2) below:

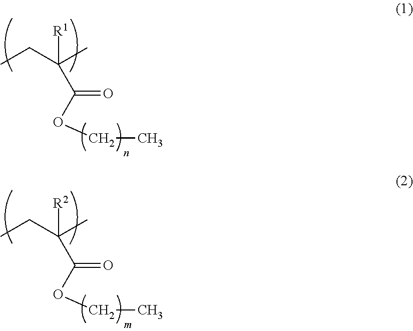

in formulae (1) and (2), R¹ and R² denote a hydrogen atom or a methyl group, n and m denote a specific integer.

### BACKGROUND OF THE INVENTION

### Field of the Invention

The present disclosure relates to a toner used in an image forming apparatus of an electrophotographic system, and a method for producing the toner.

### Description of the Related Art

In recent years, demands have increased for energy-saving measures in image forming apparatuses of electrophotographic systems. As specific energy-saving measures, techniques for fixing toners at lower temperatures have been investigated in order to reduce the amount of power consumed in fixing processes. An example of this is a method for lowering the glass transition point of a resin component in a toner in order to improve the low-temperature fixability of the toner. However, because lowering the glass transition point of a resin component in a toner leads to a decrease in the heat-resistant storage stability of the toner, it is difficult to achieve both low-temperature fixability and heat-resistant storage stability in a toner using this method.

As a result, a method involving using in the toner a crystalline resin has been investigated in order to achieve both low-temperature fixability and heat-resistant storage stability in a toner. Amorphous resins commonly used as binder resins of toners do not produce a clear endothermic peak in differential scanning calorimetric measurements (DSC measurements). However, crystalline resins produce endothermic peaks. This is because crystalline resins have the characteristic of hardly softening up to the melting point thereof, and then suddenly melting (sharp melting properties) and softening once the melting point is reached. Attention has been focused on toners in which crystalline resins are used in binder resins, which can achieve both low-temperature fixability and heat-resistant storage stability because sharp melt properties are possible.

A crystalline vinyl resin can be given as an example of crystalline resin used in a binder resin of a toner. Crystalline vinyl resins are vinyl-based polymers in which a monomer unit having a long chain alkyl group is incorporated in the main chain of the polymer. A long chain alkyl group is present as a side chain as well as in the main chain skeleton, and crystalline properties are exhibited as a result of crystallization caused by long chain alkyl groups in side chains being arranged in an ordered manner within molecules and between molecules. For example, Japanese Patent Application Publication No. 2002-108018 discloses a toner that contains a vinyl-based resin obtained using a (meth)acrylic acid ester.

### SUMMARY OF THE INVENTION

A crystallized crystalline vinyl resin has the characteristic of forming a lamellar structure. A lamellar structure in which molecules are arranged in an ordered manner has the advantageous properties of molecules readily loosening and low temperature fixing being possible, but also has the property that impact resistance varies depending on angle at which an impact occurs.

For example, cracks that occur parallel to a lamellar structure readily extend and enlarge in the direction of progression thereof. Therefore, a toner in which a crystalline vinyl resin is used as a binder resin may become chipped over time if subjected to impacts. In addition, streaks and cracks that occur as a result of a fixed image being bent may enlarge.

Japanese Patent Application Publication No. 2014-130243 indicates that if an amorphous resin having an SP value similar to that of a binder resin (a core) that is a crystalline vinyl resin is used as a shell, bending resistance is improved. Here, the mechanism by which bending resistance is improved is due to affinity between the core and shell, which melt at the time of fixing, and main chains of the core and shell becoming entangled. Meanwhile, Japanese Patent Application Publication No. 2019-219646 indicates that by enhancing the elasticity of a crystalline vinyl resin itself by using a crosslinking agent in which the SP value is specified so as not to impair crystallization, durability and bending resistance are improved.

However, as a result of diligent research, the inventors of the present invention established that in Japanese Patent Application Publication No. 2014-130243, durability of a toner prior to fixing is insufficient and that bending resistance of a fixed image tends to decrease if the toner laid-on level is high. The inventors of the present invention surmised that a reason for insufficient durability is that there was insufficient adhesion between the amorphous resin of the shell and crystalline portions of the crystalline vinyl resin.

That is, it is thought that even if there is affinity between the resins of the shell and the core, there are few interactions between crystals formed by side chains of the crystalline vinyl resin and the amorphous resin of the shell, and adhesion between the shell and the crystals is insufficient. Therefore, it is thought that the shell does not adequately perform the role of stopping cracks in crystals. For similar reasons, it is thought that bending resistance tends to decrease in the case of a fixed image having a high toner laid-on level, in which cracks are thought to occur comparatively easily.

Meanwhile, it is understood from repeated research that in Japanese Patent Application Publication No. 2019-219646, bending resistance is insufficient in a fixed image having a low toner laid-on level. The reason for this is thought to be as follows. Japanese Patent Application Publication No. 2019-219646 indicates that durability and bending resistance are improved by using a crosslinking agent. However, it is predicted that if elasticity increases, adhesion between toner particles at the time of fixing and affinity of a toner for a paper tend to decrease. Therefore, there are no problems in a fixed image in which the toner laid-on level is sufficient, but if an image which has a low laid-on level and which is fixed in a state where the amount of toner is low is bent, it is thought that the toner readily detaches from the paper and bending resistance decreases.

The present disclosure provides a toner which exhibits excellent bending resistance regardless of the toner laid-on level and which also exhibits excellent low-temperature fixability and durability; and a method for producing the toner.

The present disclosure relates to a toner comprising a toner particle comprising a binder resin, wherein

the binder resin comprises a resin A and a resin B,

in a differential scanning calorimetric measurement using the toner as a sample, an endothermic peak derived from the resin A is observed, a peak top temperature of the largest endothermic peak derived from the resin A is present within a temperature range of 50.0 to 90.0° C. and an endothermic amount of the endothermic peak derived from the resin A is 30 to 70 J/g per 1 g of the toner,

a ratio of content of the resin A in the toner particle is 60.0 to 90.0 mass %,

the resin A comprises 40.0 to 70.0 mass % of a monomer unit (a) represented by formula (1) below, and

the resin B comprises 5.0 to 30.0 mass % of a monomer unit (b) represented by formula (2) below.

In formula (1), R¹ denotes a hydrogen atom or a methyl group, and n denotes an integer of 15 to 31 and in formula (2), R² denotes a hydrogen atom or a methyl group, and m denotes an integer from 9 to 31.

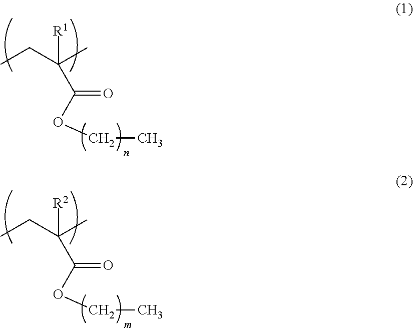

Further, the present disclosure relates to a method for producing a toner comprising a toner particle comprising a binder resin, wherein

the binder resin comprises a resin A and a resin B,

the resin A comprises 40.0 to 70.0 mass % of a monomer unit (a) represented by the formula (1), and

the resin B comprises 5.0 to 30.0 mass % of a monomer unit (b) represented by the formula (2),

the production method comprising:

a step for producing a polymerizable monomer composition comprising the resin B and a polymerizable monomer being able to form the resin A, and

a step for polymerizing the polymerizable monomer comprised in the polymerizable monomer composition to obtain the toner particle.

According to the present disclosure, it is possible to provide a toner which exhibits excellent bending resistance regardless of the toner laid-on level and which also exhibits excellent low-temperature fixability and durability. Further features of the present invention will become apparent from the following description of exemplary embodiments.

### DESCRIPTION OF THE EMBODIMENTS

The terms “from XX to YY” and “XX to YY”, which indicate numerical ranges, mean numerical ranges that include the lower limits and upper limits that are the end points of the ranges. In cases where numerical ranges are indicated incrementally, upper limits and lower limits of the numerical ranges can be arbitrarily combined. (meth)acrylate means acrylate and/or methacrylate, and (meth)acrylic acid means acrylic acid and/or methacrylic acid.

A monomer unit is a unit that constitutes a polymer (a resin), and is a form in which a monomer (a polymerizable monomer) has reacted. For example, one monomer unit is one carbon-carbon bond segment in a main chain of a polymer obtained by polymerizing a vinyl-based monomer. A vinyl-based monomer can be represented by formula (Z) below, and a vinyl-based monomer unit is a constituent unit of a polymer and is a form in which a monomer represented by formula (Z) below has reacted. In addition, a monomer unit may be referred to simply as a “unit” in some cases. In formula (Z), R_{Z1} denotes a hydrogen atom or an alkyl group (preferably an alkyl group with 1 to 3 carbon atoms, and more preferably a methyl group), and R_{Z2} denotes an arbitrary substituent group.

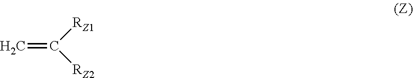

A crystalline resin means a resin that gives a clear endothermic peak in differential scanning calorimetric measurements (differential scanning calorimetric measurements are also referred to as DSC measurements).

As a result of investigations relating to the problems mentioned above, the inventors of the present invention found that in order to ensure sufficient durability and bending resistance in a toner containing a crystalline vinyl resin, it is essential that (1) there is high adhesion between a crystalline vinyl resin and crystalline portions in a resin that is used in combination with the crystalline vinyl resin, and that (2) there is good affinity between toner particles and between a toner and a resin at the time of fixing.

As a result of diligent research, the inventors of the present invention found that the problems mentioned above could be solved by appropriately controlling endothermic peaks and endothermic quantities of a toner and the content of a crystalline vinyl resin used as a primary component of the toner and by additionally using a resin containing a specific monomer that is similar to a monomer used in the crystalline vinyl resin. Specifically, this specific monomer is similar to a monomer which forms a side chain for imparting crystallinity and which is contained in the crystalline vinyl resin that serves as a primary component of the toner. A resin (an amorphous resin) which contains a small quantity of the specific monomer and which does not have a clear endothermic peak in differential scanning calorimetric measurements was used in a binder resin of a toner, in combination with the crystalline vinyl resin. It was understood that by configuring in this way, it is possible to achieve excellent durability and bending resistance while maintaining excellent low-temperature fixability.

Therefore, the present disclosure relates to a toner comprising a toner particle comprising a binder resin, wherein

the binder resin comprises a resin A and a resin B,

in a differential scanning calorimetric measurement using the toner as a sample, an endothermic peak derived from the resin A is observed, a peak top temperature of the largest endothermic peak derived from the resin A is present within a temperature range of 50.0 to 90.0° C. and an endothermic amount of the endothermic peak derived from the resin A is 30 to 70 J/g per 1 g of the toner,

a ratio of content of the resin A in the toner particle is 60.0 to 90.0 mass %,

the resin A comprises 40.0 to 70.0 mass % of a monomer unit (a) represented by formula (1) above, and

the resin B comprises 5.0 to 30.0 mass % of a monomer unit (b) represented by formula (2) above.

[In formula (1), R¹ denotes a hydrogen atom or a methyl group, and n denotes an integer of 15 to 31, and in formula (2), R² denotes a hydrogen atom or a methyl group, and m denotes an integer of 9 to 31.]

First, the inventors of the present invention think that the mechanism by which excellent durability can be achieved is as follows. By incorporating a monomer similar to that of the resin A in the resin B, interactions between side chains occur between the resin A and the resin B in the toner, and adhesion increases between the resin A, which has a lamellar structure, and the resin B, which does not have a lamellar structure. As a result, it is thought that the resin B tends to stop expansion of cracks that have occurred in the resin A and excellent durability can be achieved. It is thought that the predicted mechanism by which excellent bending resistance is achieved is similar in a fixed image in which the toner laid-on level is high. It is thought that another reason is that the resin B is readily dispersed in crystals of the resin A in a fixed image, and this effectively stops cracks.

The inventors of the present invention think that the mechanism by which excellent bending resistance is achieved in a fixed image in which the toner laid-on level is low is as follows. The resin A contains a large amount of long chain alkyl groups in side chains, and is therefore highly hydrophobic and exhibits low affinity for paper. It is thought that by dispersing the resin B, which does not contain a large amount of alkyl groups and exhibits relatively low hydrophobicity, affinity for paper can be improved. In addition, because the resin A and the resin B readily bond with each other, it is thought that adhesion between adjacent toners in a fixed image is unlikely to be impaired, and that the toner is unlikely to become detached from the paper as a result of bending.

Physical Properties of Toner and Toner Particle

In differential scanning calorimetric measurements using the toner as a sample, an endothermic peak derived from the resin A is observed, and the peak top temperature of the largest endothermic peak derived from the resin A is present within a temperature range 50.0 to 90.0° C. If a toner has an endothermic peak, this shows that the resin A is comprised in a crystalline state in the toner. A toner having excellent storability is formed if the peak top temperature of the largest endothermic peak is 50.0° C. or higher, and a toner having excellent low-temperature fixability is formed if the peak top temperature of the largest endothermic peak is 90.0° C. or lower. Therefore, if a melting point is present within the range mentioned above, the toner can exhibit both low-temperature fixability and heat-resistant storage stability. This melting point is more preferably 50.0 to 70.0° C. in order to further improve low-temperature fixability.

In addition, the endothermic quantity of an endothermic peak derived from the resin A is 30 to 70 J/g per 1 g of toner. In a case where a plurality of endothermic peaks derived from the resin A are observed, the endothermic quantity of the present invention is taken to be the total of the endothermic quantities of this plurality of peaks. The endothermic quantity indicates the quantity of the resin A present in a crystalline state in the toner, and if this endothermic quantity is 30 J/g or more, a toner having excellent low-temperature fixability and heat-resistant storage stability is formed. In addition, if this endothermic quantity is 70 J/g or less, cracks in crystals are unlikely to extend and a toner having excellent bending resistance is formed. This endothermic quantity is preferably 35 to 60 J/g, and more preferably 40 to 50 J/g. This endothermic quantity can be controlled by altering the type and quantity of long chain alkyl groups in the resin A being used or the content of the resin A in the toner particle.

Resin Components

The toner particle comprises at least the resin A and the resin B.

Resin A

The resin A comprises a monomer unit (a) that is a monomer unit represented by formula (1) below.

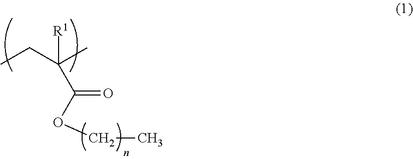

In formula (1), R¹ denotes a hydrogen atom or a methyl group, and n denotes an integer of 15 to 31.

Because the monomer unit (a) in the resin A, which is a vinyl-based polymer, has a long chain alkyl group (an alkyl group having 16 to 32 carbon atoms) as a side chain of the resin A, the resin A exhibits crystallinity and a toner having excellent low-temperature fixability and heat-resistant storage stability can be obtained. In addition, the resin A is preferably a resin that produces a clear endothermic peak in DSC measurements, that is, is preferably a crystalline resin. The monomer unit (a) can be incorporated as a monomer unit of the resin A by subjecting a (meth)acrylic acid ester having an alkyl group with 16 to 32 carbon atoms to vinyl polymerization as a polymerizable monomer.

Examples of (meth)acrylic acid esters having an alkyl group with 16 to 32 carbon atoms include (meth)acrylic acid esters having an alkyl group with 16 to 32 carbon atoms [cetyl (meth)acrylate, stearyl (meth)acrylate, nonadecyl (meth)acrylate, eicosyl (meth)acrylate, heneicosyl (meth)acrylate, behenyl (meth)acrylate, lignoceryl (meth)acrylate, ceryl (meth)acrylate, octacosyl (meth)acrylate, myricyl (meth)acrylate, and the like].

Of these, at least one selected from the group consisting of (meth)acrylic acid esters having a straight chain alkyl group with 16 to 32 carbon atoms is preferred from the perspectives of low-temperature fixability and heat-resistant storage stability of a toner, at least one selected from the group consisting of (meth)acrylic acid esters having an alkyl group with 18 to 30 carbon atoms is more preferred, and at least one selected from the group consisting of straight chain stearyl (meth)acrylate and behenyl (meth)acrylate is further preferred. That is, the number of carbon atoms (n) in formula (1) above is preferably 15 to 29, more preferably 17 to 29, and further preferably 17 or 21. In addition, R¹ is preferably a hydrogen atom.

The polymerizable monomer that forms the monomer unit (a) (hereinafter also referred to as the monomer (a)) and the monomer unit (a) may be a single type or a combination of two or more types. The content of the monomer unit (a) in the resin A is 40.0 to 70.0 mass %. If this content is 40.0 mass % or more, a toner having excellent low-temperature fixability and heat-resistant storage stability can be obtained. This content is preferably 45.0 mass % or more. However, if this content is 70.0 mass % or less, the degree of hydrophobicity and the amount of lamellar structures are appropriate, and a toner having excellent bending resistance can be obtained regardless of the toner laid-on level. This content is preferably 65.0 mass % or less, and more preferably 60.0 mass % or less. In addition, the same applies to a case where a plurality of monomer units (a) are present, with the content of the monomer unit (a) taken to be the total content of all monomer units represented by formula (1) above.

The content of the resin A in the toner particle is 60.0 to 90.0 mass %. If this content is 60.0 mass % or more, a toner having excellent low-temperature fixability can be obtained. This content is preferably 70.0 mass % or more, more preferably 75.0 mass % or more, and further preferably 80.0 mass % or more. It is preferable for the resin A to account for the entire balance of components in the toner excluding the resin B and additives such as a coloring agent and a release agent. However, this content is preferably 85.0 mass % or less.

From the perspective of appropriately controlling physical properties of the toner, the resin A preferably comprises a monomer unit (c) (another monomer unit (c)) different from the monomer unit (a) mentioned above. The monomer unit (c) (another monomer unit) can be incorporated as a monomer unit of the resin A by subjecting a polymerizable monomer described later (hereinafter also referred to as the other monomer) to vinyl polymerization together with the polymerizable monomer that forms the monomer unit (a). If the SP value of the monomer unit (a) is denoted by SPa and the SP value of the monomer unit (c) is denoted by SPc, then formula (3) below is preferably satisfied.

3.0≤(SPc−SPa)≤25.0 (3)

The value of SPc-SPa is more preferably from 5.0 to 10.0. If formula (3) above is satisfied, the crystallinity of the resin A is unlikely to decrease and a melting point tends to be maintained. Due to this configuration, a balance between low-temperature fixability and heat-resistant storage stability tends to be achieved.

Moreover, in a case where the monomer unit (a) comprises two or more types of (meth)acrylic acid ester having an alkyl group with 16 to 32 carbon atoms, SPa is expressed as an average value calculated from the molar ratio of the quantities of the monomers (a) that form the monomer units.

On the other hand, in a case where the monomer unit (c) comprises two or more types of polymerizable monomer, SPc denotes the SP values of monomer units derived from the polymerizable monomers, and the value of SPc-SPa is determined for monomer units derived from the polymerizable monomers.

The content of the monomer unit (c) satisfying formula (3) in the resin A is preferably 20.0 mass % or more, and more preferably 25.0 mass % or more. If the content of the monomer unit (c) is 20.0 mass % or more, the sharp melt properties of the resin A are readily exhibited, and low-temperature fixability is improved. In addition, crystallinity is unlikely to decrease and a melting point is readily maintained, and heat-resistant storage stability is therefore improved. The upper limit of this content is not particularly limited, but is preferably 40.0 mass % or less, and more preferably 35.0 mass % or less. Moreover, in a case where two or more types of monomer unit (c) that satisfy formula (3) above are present in the resin A, the proportion of the monomer unit (c) is taken to be the total mass percentage of these.

Examples of the polymerizable monomer (c) that forms the monomer unit (c) include polymerizable monomers that satisfy formula (3) above among the polymerizable monomers listed below. The polymerizable monomer (c) may be a single monomer or a combination of two or more types.

A monomer having a nitrile group; for example, acrylonitrile and methacrylonitrile.

A monomer having a hydroxy group: for example, 2-hydroxyethyl (meth)acrylate, 2-hydroxypropyl (meth)acrylate, and the like.

A monomer having an amide group: for example, acrylamide and a monomer obtained by reacting an amine having from 1 to 30 carbon atoms and a carboxylic acid having an ethylenically unsaturated bond having from 2 to 30 carbon atoms (acrylic acid, methacrylic acid, and the like) by a known method.

A monomer having a urethane group: for example, a monomer obtained by reacting an alcohol having from 2 to 22 carbon atoms (2-hydroxyethyl methacrylate, vinyl alcohol, and the like) and an ethylenically unsaturated bond and an isocyanate having from 1 to 30 carbon atoms [a monoisocyanate compound (benzenesulfonyl isocyanate, tosyl isocyanate, phenyl isocyanate, p-chlorophenyl isocyanate, butyl isocyanate, hexyl isocyanate, t-butyl isocyanate, cyclohexyl isocyanate, octyl isocyanate, 2-ethylhexyl isocyanate, dodecyl isocyanate, adamantyl isocyanate, 2,6-dimethylphenyl isocyanate, 3,5-dimethylphenyl isocyanate, 2,6-dipropylphenylisocyanate, and the like), an aliphatic diisocyanate compound (trimethylene diisocyanate, tetramethylene diisocyanate, hexamethylene diisocyanate, pentamethylene diisocyanate, 1,2-propylene diisocyanate, 1,3-butylene diisocyanate, dodecamethylene diisocyanate, 2,4,4-trimethylhexamethylene diisocyanate, and the like), an alicyclic diisocyanate compound (1,3-cyclopentene diisocyanate, 1,3-cyclohexane diisocyanate, 1,4-cyclohexane diisocyanate, isophorone diisocyanate, hydrogenated diphenylmethane diisocyanate, hydrogenated xylylene diisocyanate, hydrogenated tolylene diisocyanate, hydrogenated tetramethylxylylene diisocyanate, and the like), and an aromatic diisocyanate compound (phenylene diisocyanate, 2,4-tolylene diisocyanate, 2,6-tolylene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate, xylylene diisocyanate, and the like)], and the like by a known method;

a monomer obtained by reacting an alcohol having from 1 to 26 carbon atoms (methanol, ethanol, propanol, isopropyl alcohol, butanol, t-butyl alcohol, pentanol, heptanol, octanol, 2-ethylhexanol, nonanol, decanol, undecyl alcohol, lauryl alcohol, dodecyl alcohol, myristyl alcohol, pentadecyl alcohol, cetanol, heptadecanol, stearyl alcohol, isostearyl alcohol, elaidyl alcohol, oleyl alcohol, linoleil alcohol, linolenyl alcohol, nonadecyl alcohol, heneicosanol, behenyl alcohol, erucyl alcohol, and the like) and an isocyanate having from 2 to 30 carbon atoms and an ethylenically unsaturated bond [2-isocyanatoethyl (meth)acrylate, 2-(0-[1′-methylpropylidenamino]carboxyamino])ethyl meth(acrylate), 2-[(3,5-dimethylpyrazolyl)carbonylamino]ethyl (meth)acrylate, 1,1-(bis(meth)acryloyloxymethyl)ethyl isocyanate, and the like] by a known method; and the like.

A monomer having a urea group; for example, a monomer obtained by reacting an amine having from 3 to 22 carbon atoms [primary amines (normal butylamine, t-butylamine, propylamine, isopropylamine, and the like), secondary amines (dinormalethylamine, dinormalpropylamine, dinormal butylamine, and the like), aniline, cycloxylamine, and the like] with an isocyanate having from 2 to 30 carbon atoms and an ethylenically unsaturated bond by a known method.

A monomer having a carboxy group; for example, methacrylic acid, acrylic acid, and 2-carboxyethyl (meth)acrylate.

In addition, vinyl esters such as vinyl acetate, vinyl propionate, vinyl butyrate, vinyl caproate, vinyl caprylate, vinyl caprate, vinyl laurate, vinyl myristate, vinyl palmitate, vinyl stearate, vinyl pivalate and vinyl octanoate can be used as the polymerizable monomer (c).

Of these, the monomer unit (c) is preferably at least one selected from the group consisting of monomer units represented by formulae (4a) to (4c) below, and is more preferably represented by formula (4) below.

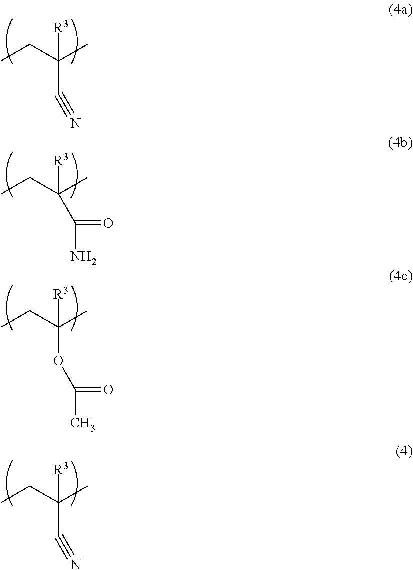

In the formula, R³ each independently denotes a hydrogen atom or a methyl group.

By incorporating a monomer unit represented by formula (4) above, crystallization of the resin A is unlikely to be impaired and the melting point readily increases, and low-temperature fixability and heat-resistant storage stability are therefore improved. A monomer that forms the monomer unit (c) is preferably at least one selected from the group consisting of (meth)acrylonitrile, (meth)acrylamide and vinyl acetate. Acrylonitrile and methacrylonitrile are more preferred.

In addition to the monomer unit (a) and the monomer unit (c) that satisfies formula (3) above, the resin A may contain one or more other monomer units that do not satisfy formula (3) above. The unit that does not satisfy formula (3) above is not particularly limited, but preferably comprises a polymerizable monomer such as those listed below, other than the polymerizable monomers mentioned above.
(Meth)acrylic acid esters: methyl (meth)acrylate, ethyl (meth)acrylate, n-butyl (meth)acrylate, t-butyl (meth)acrylate, 2-ethylhexyl (meth)acrylate, and the like Styrene compounds: styrene, α-methylstyrene, and the like

Of these, use of ethyl methacrylate, n-butyl methacrylate, t-butyl methacrylate or styrene is preferred from the perspective of being able to appropriately control the elasticity of the toner. That is, the resin A preferably has at least one selected from the group consisting of a monomer unit represented by formula (St) below, which is obtained by polymerizing styrene, and a monomer unit represented by formula (Ac) below, which is obtained by polymerizing a (meth)acrylic acid ester. The resin A more preferably has a monomer unit represented by formula (St) below. In formula (Ac), R⁶ denotes a hydrogen atom or a methyl group, and R⁷ denotes an alkyl group having 1 to 4 carbon atoms (preferably 1 to 3 carbon atoms, more preferably 1 or 2 carbon atoms, and further preferably 2 carbon atoms).

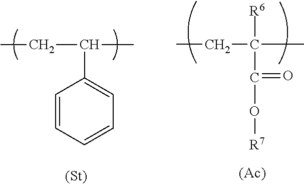

The content of the monomer unit represented by formula (St) in the resin A is preferably 1.0 to 30.0 mass %, and more preferably 4.0 to 25.0 mass %. The content of the monomer unit represented by formula (Ac) in the resin A is preferably 0.0 to 20.0 mass %, and more preferably 5.0 to 15.0 mass %.

The acid value AvA of the resin A is preferably 5.0 mg KOH/g or less. A polymerizable monomer able to impart the resin A with an acid value tends to impair crystallization of the monomer unit (a). Therefore, if the acid value AvA is 5.0 mg KOH/g or less, crystallinity of the resin A becomes more suitable and low-temperature fixability and heat-resistant storage stability tend to improve. This acid value AvA is more preferably from 0 mg KOH/g to 3.0 mg KOH/g, and further preferably from 0 mg KOH/g to 1.0 mg KOH/g, and it is further preferable for the resin A to have no acid value, that is, 0 mg KOH/g.

Resin B

The resin B comprises a monomer unit (b) that is a monomer unit represented by formula (2) below.

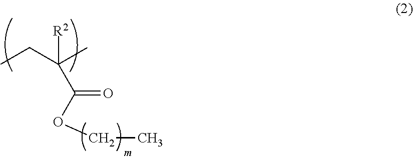

In formula (2), R² denotes a hydrogen atom or a methyl group, and m denotes an integer of 9 to 31.

Because the monomer unit (b) in the resin B has a long chain alkyl group (an alkyl group having 10 to 32 carbon atoms) having a similar structure to a side chain of the monomer unit (a) that imparts the resin A with crystallinity, the resin A and the resin B tend to have affinity with each other, and the resin B and crystals of the resin A readily adhere with each other due to interactions between long chain alkyl groups. Therefore, it is assumed that the mechanism described above occurs, and a toner having excellent durability and bending resistance can be obtained. In addition, the resin B is preferably a resin without a clear endothermic peak in DSC measurements, that is, is preferably an amorphous resin. The glass transition temperature TgB of the resin B is preferably 30.0 to 90.0° C., and more preferably 50.0 to 80.0° C.

Because the resin B is amorphous, crystals of the resin A are unlikely to be connected across a wide range, and because the resin B readily fulfills the role of stopping cracks, durability and bending resistance of images having a high toner laid-on level are improved. Heat-resistant storage stability is improved if the value of TgB is 30.0° C. or higher, and low-temperature fixability is improved if the value of TgB is 90.0° C. or lower.

The monomer unit (b) can be incorporated as a monomer unit of the resin B by subjecting a (meth)acrylic acid ester having an alkyl group with 10 to 32 carbon atoms to vinyl polymerization as a polymerizable monomer. The number of carbon atoms (m) is preferably 11 to 29, and more preferably 15 to 23.

Examples of (meth)acrylic acid esters having an alkyl group with 10 to 32 carbon atoms include (meth)acrylic acid esters having a straight chain alkyl group with 10 to 32 carbon atoms [decyl (meth)acrylate, hendecyl (meth)acrylate, lauryl (meth)acrylate, tridecyl (meth)acrylate, tetradecyl (meth)acrylate, pentadecyl (meth)acrylate, cetyl (meth)acrylate, heptadecyl (meth)acrylate, stearyl (meth)acrylate, nonadecyl (meth)acrylate, eicosyl (meth)acrylate, heneicosyl (meth)acrylate, behenyl (meth)acrylate, lignoceryl (meth)acrylate, ceryl (meth)acrylate, octacosyl (meth)acrylate, myricyl (meth)acrylate, and the like].

Of these, the absolute value of the difference |n−m| between the value of n in formula (1), that is, the number of carbon atoms (n) in the long chain alkyl group in the monomer unit (a), and the value of m in a formula (2), that is, the number of carbon atoms (m) in the long chain alkyl group in the monomer unit (b), is preferably 10 or less. If the values of n and m are similar, interactions between long chain alkyl groups are further enhanced, adhesion between the resin A and the resin B tends to increase, and durability and bending resistance are therefore improved. The value of |n−m| is preferably from 0 to 5, more preferably from 0 to 2, and further preferably 0. The resin B may be obtained using one monomer unit (b) in isolation or a combination of two or more types.

The content of the monomer unit (b) in the resin B is 5.0 to 30.0 mass %. If this content is 5.0 mass % or more, the resin A and the resin B tend to exhibit affinity with each other, adhesive properties are improved, and a toner having excellent durability and bending resistance can therefore be obtained. Furthermore, because the resin B is readily dispersed in the resin A, which melts at the time of fixing, it is possible to achieve excellent durability and bending resistance (at a high laid-on level). In addition, toner particles readily stick together in a fixed image, and excellent bending resistance (at a high laid-on level) can be achieved. However, if this content is 30.0 mass % or less, the resin B is unlikely to crystallize, a lamellar structure is unlikely to be formed, and cracks are therefore unlikely to enlarge. In addition, because the resin B bonds to the resin A while having a different composition from the resin A and being unlikely to be compatible with the resin A, extension of cracks can be easily prevented.

Therefore, it is possible to achieve excellent durability and bending resistance (at a high laid-on level). The content of the monomer unit (b) represented by formula (2) in the resin B is preferably 5.0 to 25.0 mass %, and more preferably 10.0 to 20.0 mass %. Moreover, the content of the monomer unit (b) is taken to be the total content of all monomer units represented by formula (2) above. The same is true for a case in which a plurality of monomer units (b) are present.

In addition to the monomer unit (b), the resin B may comprise one or more other monomer units that do not satisfy the conditions mentioned above. Examples of polymerizable monomers that form these other monomer units include monomers that form the monomer unit (c) and other monomer units that have been exemplified in relation to the resin A.

The resin B preferably comprises at least one selected from the group consisting of a monomer unit represented by formula (7) below and a monomer unit represented by formula (8) below. The resin B more preferably comprises monomer units represented by formula (7) and formula (8) below. In addition, the resin B more preferably also comprises a monomer unit represented by formula (St) below. In the formula, R⁸ and R⁹ each denote a hydrogen atom or a methyl group, and R¹⁰ denotes a hydrogen atom, an alkyl group having 1 to 4 carbon atoms (preferably 1 to 3 carbon atoms, more preferably 1 or 2 carbon atoms, and further preferably 2 carbon atoms) or a hydroxyalkyl group having 1 to 4 carbon atoms (and preferably 1 to 3 carbon atoms).

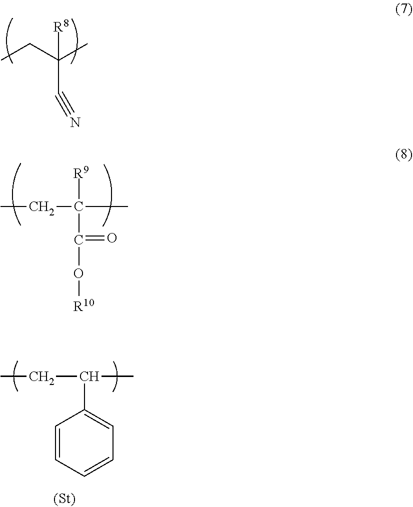

The content of the monomer unit represented by formula (7) in the resin B is preferably 3.0 to 25.0 mass %, and more preferably 10.0 to 20.0 mass %. The content of the monomer unit represented by formula (8) in the resin B is preferably 0.5 to 35.0 mass %, and more preferably 2.0 to 30.0 mass %. The content of the monomer unit represented by formula (St) in the resin B is preferably 40.0 to 80.0 mass %, and more preferably 50.0 to 70.0 mass %.

The content of the resin B in the toner particle is preferably 1.0 to 20.0 mass %. Durability and bending resistance are improved if this content is 1.0 mass % or more, and low-temperature fixability is improved if this content is 20.0 mass % or less. This content is more preferably 2.0 to 15.0 mass %, and further preferably 3.0 to 8.0 mass %.

In addition, the weight average molecular weight MwB of tetrahydrofuran (THF)-soluble matter in the resin B, as measured by means of gel permeation chromatography (GPC), is preferably 10,000 to 20,000, and more preferably 15,000 to 19,500. If this MwB value is 10,000 or more, the resin B is highly elastic and readily fulfills the role of stopping cracks. If this MwB value is 20,000 or less, the resin B tends to be in a finely dispersed state in the resin A, and cracks are unlikely to extend. Therefore, if this MwB value falls within the range mentioned above, bending resistance (at a high laid-on level) tends to be improved. In addition, if this MwB value is 20,000 or less, bonding of toner particles at the time of fixing tends not to be impaired by the resin B, and bending resistance (at a high laid-on level) tends to be improved.

The acid value AvB of the resin B is preferably 5.0 to 30.0 mg KOH/g. If this acid value AvB is 5.0 mg KOH/g or more, the hydrophilicity of the toner is improved, affinity for paper tends to increase, and bending resistance (at a high laid-on level) therefore tends to be improved. If this acid value AvB is 30.0 mg KOH/g or less, the acid value of the resin B tends to approach that of the monomer unit (a), which has a low acid value, the resin A and the resin B readily bond with each other, and durability and bending resistance are therefore improved. This acid value AvB is more preferably 10.0 to 30.0 mg KOH/g.

The difference between the acid value AvA of the resin A and the acid value AvB of the resin B (AvB−AvA) is preferably 5.0 mg KOH/g or more. If this difference is 5.0 mg KOH/g or more, the resin B and the resin A bond with each other while not being completely compatible with the resin A, and readily fulfills the role of preventing cracks from extending. Therefore, durability and bending resistance tend to be improved. The value of AvB−AvA is more preferably 10.0 mg KOH/g or more. The upper limit for the value of AvB−AvA is not particularly limited, but is preferably 30.0 mg KOH/g or less, and more preferably 20.0 mg KOH/g or less.

In addition, if the SP value of the resin A is denoted by SPA (J/cm³)^{0.5} and the SP value of the resin B is denoted by SPB (J/cm³)^{0.5}, the then absolute value of the difference between SPA and SPB (|SPA−SPB|) preferably satisfies formula (5) below.

0.2≤|SPA−SPB|≤2.0 (5)

If the value of |SPA−SPB| is 0.2 or more, the resin B is unlikely to be in a state that is completely compatible with the resin A, and the resin B therefore tends to function as a resin that stops cracks. Therefore, durability and bending resistance tend to be improved. In addition, if the value of |SPA−SPB| is 2.0 or less, the resin A and the resin B tend to form a bonded state, and durability and bending resistance therefore tend to be improved. That is, if the relational expression above is fulfilled, even if the resin A and the resin B bond to each other, the resin B is not compatible with the resin A, and a state in which these resins are each present in isolation tends to be formed. More preferably, 0.2≤|SPA−SPB|≤1.6.

The total content of the resin A and the resin B in the binder resin is preferably 80.0 mass % or more. This total content is more preferably 90.0 to 100.0 mass %, and further preferably 95.0 to 100.0 mass %. If this total content falls within the range mentioned above, the low-temperature fixability attributable to the resin A tends to be better exhibited.

Resins Other than Resins A and B

In addition to the resin A and the resin B, the binder resin may contain another resin able to be used as a resin component of the toner. Examples thereof include vinyl-based resins that do not correspond to the resin A or the resin B, polyester resins, polyurethane resins and epoxy resins.

In a case where the other resin is a vinyl-based resin, monomers able to be used in the resin A and the resin B can be used as a combination that does not correspond to the resin A and the resin B. If necessary, 2 or more monomers may be used in combination in the other resin.

The polyester resin can be obtained by the polycondensation reaction of a polyvalent carboxylic acid having a valence of two or higher and a polyhydric alcohol. Examples of the polyvalent carboxylic acid include the following compounds. Dibasic acids such as amber acid, adipic acid, sebacic acid, phthalic acid, isophthalic acid, terephthalic acid, malonic acid, dodecenyl succinic acid, and anhydrides thereof or lower alkyl esters thereof, aliphatic unsaturated dicarboxylic acid such as maleic acid, fumaric acid, itaconic acid, and citraconic acid, 1,2,4-benzenetricarboxylic acid, 1,2,5-benzenetricarboxylic acid, and anhydrides thereof or lower alkyl esters thereof. These may be used alone or in combination of two or more.

Examples of the polyhydric alcohol include the following compounds. Alkylene glycols (ethylene glycol, 1,2-propylene glycol and 1,3-propylene glycol); alkylene ether glycols (polyethylene glycol and polypropylene glycol); alicyclic diols (1,4-cyclohexanedimethanol); bisphenols (bisphenol A); and alkylene oxides of alicyclic diols (ethylene oxide and propylene oxide) adducts. The alkyl portion of the alkylene glycols and the alkylene ether glycols may be linear or branched. Other examples include glycerin, trimethylolethane, trimethylolpropane, pentaerythritol, and the like. These may be used alone or in combination of two or more.

Moreover, in order to adjust the acid value or hydroxyl value, monovalent acids such as acetic acid and benzoic acid and monohydric alcohols such as cyclohexanol and benzyl alcohol may be used if necessary. The method for producing a polyester resin is not particularly limited, but examples thereof include a transesterification method and a direct polycondensation method.

A polyurethane resin can be obtained through a reaction between a diol component and a diisocyanate component.

Examples of the diisocyanate component include the following. Aromatic diisocyanates having from 6 to 20 carbon atoms (excluding carbons in the NCO group, the same applies hereinafter), aliphatic diisocyanates having from 2 to 18 carbon atoms, alicyclic diisocyanates having from 4 to 15 carbon atoms, and modified products of these diisocyanates (modified products including a urethane group, a carbodiimide group, an allophanate group, a urea group, a biuret group, a uretdione group, a uretoimine group, an isocyanurate group or an oxazolidone group; hereinafter also referred to as “modified diisocyanate”), and mixtures of two or more thereof.

Examples of the aromatic diisocyanates include the following. m- and/or p-xylylene diisocyanate (XDI) and α,α,α′,α′-tetramethylxylylene diisocyanate.

Examples of the aliphatic diisocyanates include the following. Ethylene diisocyanate, tetramethylene diisocyanate, hexamethylene diisocyanate (HDI) and dodecamethylene diisocyanate.

Further, examples of the alicyclic diisocyanates include the following. Isophorone diisocyanate (IPDI), dicyclohexylmethane-4,4′-diisocyanate, cyclohexylene diisocyanate, and methylcyclohexylene diisocyanate.

Among these, aromatic diisocyanates having from 6 to 15 carbon atoms, aliphatic diisocyanates having from 4 to 12 carbon atoms, and alicyclic diisocyanates having from 4 to 15 carbon atoms are preferable, and XDI, IPDI and HDI are particularly preferable. Further, in addition to the diisocyanate component, a trifunctional or higher functional isocyanate compound can also be used. As the diol components that can be used for the polyurethane resin, the same divalent alcohols that can be used for the polyester resin described above can be used.

Wax

The toner particle may contain a wax as a release agent. The wax is not particularly limited, but a hydrocarbon wax and/or an ester wax are preferred. By using a hydrocarbon wax and/or an ester wax, effective release properties tend to be ensured. The hydrocarbon wax is not particularly limited, but examples thereof are as follows.

Aliphatic hydrocarbon waxes: low-molecular-weight polyethylene, low-molecular-weight polypropylene, a low-molecular-weight olefin copolymer, Fisher Tropsch wax, or wax obtained by oxidizing and acidifying these.

The ester wax may have at least one ester bond in one molecule, and either natural ester wax or synthetic ester wax may be used. The ester wax is not particularly limited, and examples thereof include the following.

Esters of monohydric alcohols and monocarboxylic acids, such as behenic behenate, stearyl stearate, palmitic palmitate, and the like;

esters of divalent carboxylic acids and monohydric alcohols, such as dibehenyl sebacate and the like;

esters of dihydric alcohols and monocarboxylic acids, such as ethylene glycol distearate, hexanediol dibehenate, and the like

esters of trihydric alcohols and monocarboxylic acids, such as glycerin tribehenate and the like;

esters of a tetrahydric alcohol and monocarboxylic acids, such as pentaerythritol tetrastearate, pentaerythritol tetrapalmitate, and the like;

esters of hexahydric alcohols and monocarboxylic acids, such as dipentaerythritol hexastearate, dipentaerythritol hexapalmitate, dipentaerythritol hexabehenate, and the like;

esters of polyfunctional alcohols and monocarboxylic acids, such as polyglycerin behenate and the like; and natural ester waxes such as carnauba wax and rice wax.

Among them, esters of hexahydric alcohols and monocarboxylic acids, such as dipentaerythritol hexastearate, dipentaerythritol hexapalmitate, dipentaerythritol hexabehenate, and the like are preferable.

The wax may be a hydrocarbon wax or an ester wax in isolation, a combination of a hydrocarbon wax and an ester wax, or a mixture of two or more types of each.

Additives

If necessary, the toner may contain one or more additives selected from among a colorant, a magnetic body, a charge control agent, a fluidizing agent, and the like. Additives able to be used in the toner are explicitly in detail below.

Colorant

The toner may include a colorant. Examples of the colorant include known organic pigments, organic dyes, inorganic pigments, carbon black as a black colorant, magnetic particles and the like. In addition, a colorant conventionally used for toner may be used. Examples of yellow colorants include condensed azo compounds, isoindolinone compounds, anthraquinone compounds, azo metal complexes, methine compounds, and allylamide compounds. Specifically, C. I. Pigment Yellow 12, 13, 14, 15, 17, 62, 74, 83, 93, 94, 95, 109, 110, 111, 128, 129, 147, 155, 168, and 180 are preferably used.

Examples of magenta colorants include condensed azo compounds, diketopyrrolopyrrole compounds, anthraquinone compounds, quinacridone compounds, basic dye lake compounds, naphthol compounds, benzimidazolone compounds, thioindigo compounds, and perylene compounds. Specifically, C. I. Pigment Red 2, 3, 5, 6, 7, 23, 48:2, 48:3, 48:4, 57:1, 81:1, 122, 144, 146, 166, 169, 177, 184, 185, 202, 206, 220, 221, and 254 are preferably used.

Examples of cyan colorants include copper phthalocyanine compounds and derivatives thereof, anthraquinone compounds, basic dye lake compounds. Specifically, C. I. Pigment Blue 1, 7, 15, 15:1, 15:2, 15:3, 15:4, 60, 62, and 66 are preferably used.

These colorants may be selected in view of hue angle, chroma, lightness, lightfastness, OHP transparency and dispersibility in the toner particle. In a case where the colorant is not a magnetic particle, the content of the colorant is preferably 1.0 to 20.0 parts by mass relative to 100.0 parts by mass of the binder resin. In cases where a magnetic particle is used as a colorant, the content thereof is preferably from 40.0 parts by mass to 150.0 parts by mass relative to 100.0 parts by mass of the binder resin.

Charge Control Agent

The charge control agent is not particularly limited, and a well-known charge control agent can be used. Examples of negative charge control agents include those listed below. Monoazo metal compounds, acetylacetone metal compounds, aromatic oxycarboxylic acids, aromatic dicarboxylic acids, and oxycarboxylic acid-based and dicarboxylic acid-based metal compounds. In addition, examples of positive charge control agents include quaternary ammonium salts and polymer compounds having a quaternary ammonium salt in a side chain; guanidine compounds; pyridine-based compounds; nigrosine-based compounds; and imidazole compounds. The content of the charge control agent is preferably 0.01 to 20.0 parts by mass relative to 100.0 parts by mass of the toner particle. This content is more preferably 0.5 to 10.0 parts by mass.

External Additives

The toner may be obtained by externally adding an external additive to the toner particle. Examples of the external additive include those listed below. Inorganic fine particles selected from the group consisting of silica fine particles, alumina fine particles and titania fine particles, and composite oxides of these. Examples of composite oxides include silica-aluminum fine particles and strontium titanate fine particles. The content of the external additive is preferably 0.01 to 8.0 parts by mass relative to 100 parts by mass of the toner particle. In addition, this content is more preferably 0.1 to 4.0 parts by mass.

Toner Production Method

The method for producing the toner particle is not particularly limited, and it is possible to use a well-known method, such as a suspension polymerization method, an emulsion aggregation method, a suspension polymerization method or a pulverization method. Of these, a suspension polymerization method is preferred from the perspectives of suppressing variations in the content ratio of the resin A and the resin B between toner particles and readily improving low-temperature fixability, durability and bending resistance. Use of the production method described below is particularly preferred for producing the toner described above.

A method for producing a toner comprising a toner particle comprising a binder resin, wherein

the binder resin comprises a resin A and a resin B,

the resin A comprises 40.0 to 70.0 mass % of a monomer unit (a) represented by formula (1) above,

the resin B comprises 5.0 to 30.0 mass % of a monomer unit (b) represented by formula (2) above, and

the production method is characterized by including a step for preparing a polymerizable monomer composition comprising the resin B and a polymerizable monomer able to form the resin A; and a step for polymerizing the polymerizable monomers comprised in the polymerizable monomer composition to obtain a toner particle.

The production method described above will now be explained in detail. For the resin A and the resin B, see above. By using the production method described above, a toner having superior low-temperature fixability, durability and bending resistance tends to be obtained.

A polymerizable monomer able to form the resin A is a (meth)acrylic acid ester having an alkyl group with 16 to 32 carbon atoms. Of the polymerizable monomers contained in the polymerizable monomer composition, the content of a (meth)acrylic acid ester having an alkyl group with 16 to 32 carbon atoms is 40.0 to 70.0 mass % (preferably 45.0 to 65.0 mass %, and more preferably 45.0 to 60.0 mass %). The polymerizable monomer composition may contain a polymerizable monomer that forms the monomer unit (c), a polymerizable monomer that forms the monomer unit represented by formula (St), and a polymerizable monomer that forms the monomer unit represented by formula (Ac).

For example, the polymerizable monomer composition is prepared by adding the resin B, which has been synthesized in advance, to a mixture of polymerizable monomers for producing the resin A, adding other materials, such as a colorant, a wax, a charge control agent and a crosslinking agent, if necessary to obtain a polymerizable monomer composition, and then homogeneously dissolving or dispersing this polymerizable monomer composition. Suspended particles of the polymerizable monomer composition are then prepared by dispersing the polymerizable monomer composition in an aqueous medium using a stirring device. Toner particles are then obtained by polymerizing the polymerizable monomers contained in the particles using a polymerization initiator.

Following completion of the polymerization, the toner particle is filtered, washed and dried using well-known methods, and an external additive is added if necessary, thereby obtaining a toner. By including a step for dissolving the resin B, which has been polymerized in advance, in a liquid of unpolymerized monomers for the resin A, a state in which the resin A and the resin B bond to each other without being compatible tends to be formed. In addition, because variations in the content ratio of the resin A and the resin B between toner particles are suppressed, a toner having excellent low-temperature fixability, durability and bending resistance tends to be formed.

The polymerization initiator can be a well-known polymerization initiator. Examples thereof include azo-based and diazo-based polymerization initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile and azobisisobutyronitrile; and peroxide-based polymerization initiators such as benzoyl peroxide, t-butylperoxy 2-ethylhexanoate, t-butylperoxy pivalate, t-butylperoxy isobutyrate, t-butylperoxy neodecanoate, methyl ethyl ketone peroxide, diisopropylperoxy carbonate, cumene hydroperoxide, 2,4-dichlorobenzoyl peroxide and lauroyl peroxide.

In addition, well-known chain transfer agents and polymerization inhibitors may be used. The aqueous medium may contain an inorganic or organic dispersion stabilizer. The dispersion stabilizer can be a well-known dispersion stabilizer.

Examples of inorganic dispersion stabilizers include phosphates such as hydroxyapatite, tribasic calcium phosphate, dibasic calcium phosphate, magnesium phosphate, aluminum phosphate and zinc phosphate; carbonates such as calcium carbonate and magnesium carbonate; metal hydroxides such as calcium hydroxide, magnesium hydroxide and aluminum hydroxide; sulfates such as calcium sulfate and barium sulfate; calcium metasilicate; bentonite; silica; and alumina.

Meanwhile, examples of organic dispersion stabilizers include poly(vinyl alcohol), gelatin, methyl cellulose, methylhydroxypropyl cellulose, ethyl cellulose, sodium carboxymethyl cellulose, poly(acrylic acid) and salts thereof, and starch. In cases where an inorganic compound is used as a dispersion stabilizer, a commercially available product may be used as-is, but in order to obtain finer particles, it is possible to use a product obtained by dispersing an inorganic compound mentioned above in an aqueous medium. For example, in the case of a calcium phosphate such as hydroxyapatite or tribasic calcium phosphate, an aqueous solution of a phosphate and an aqueous solution of a calcium salt should be mixed under high speed stirring.

The aqueous medium may contain a surfactant. The surfactant can be a well-known surfactant. Examples of surfactants include anionic surfactants such as sodium dodecylbenzene sulfate and sodium oleate; cationic surfactants, amphoteric surfactants and non-ionic surfactants.

Methods for measuring physical property values and so on will now be described.

Method for Separating Resin a and Resin B from Toner

The resin A and the resin B can be separated from the toner using a well-known method, an example of which is given below. Gradient LC is used as a method for separating resin components from the toner. In this analysis, resins in the binder resin can be separated on the basis of polarity, regardless of the molecular weights of the resins. First, the toner is dissolved in chloroform. A sample is prepared so that the sample concentration in chloroform is 0.1 mass %, and this solution is filtered using a 0.45 μm PTFE filter and then subjected to measurements. Gradient polymer LC measurement conditions are as follows.

Apparatus: ULTIMATE 3000 (produced by Thermo Fisher Scientific)
Mobile phase: A: chloroform (HPLC), B: acetonitrile (HPLC)

### Gradient: 2 min (A/B=0/100)→25 min (A/B=100/0)

Moreover, the gradient of the change in mobile phase was linear.
Flow rate: 1.0 m/min
Injected amount: 0.1 mass %×20 μL
Column: Tosoh TSKgel ODS (4.6 mmφ×150 mm×5 μm)
Column temperature: 40° C.
Detector: Corona charged particle detector (Corona-CAD) (produced by Thermo Fisher Scientific)

A peak corresponding to a high polarity component, that is, the resin B, and a peak corresponding to a low polarity component, that is, the resin A, are confirmed on a time-intensity graph obtained from the measurements. In addition, in a case where a resin other than the resin A and the resin B is contained, a peak corresponding to the polarity of this other resin is also observed. Next, the measurements described above are carried out again, and it is possible to separate the resin A, the resin B and the other resin by isolating at times corresponding to valleys between peaks.

Moreover, in a case where the toner contains a release agent, it is essential to separate the release agent from the toner. Separation of the release agent involves separating a component having a molecular weight of 2000 or less as a release agent by means of recycling HPLC. The measurement method is as follows. First, a chloroform solution of the toner is produced using the method described above. A sample solution is then obtained by filtering the obtained solution using a solvent-resistant membrane filter having a pore diameter of 0.2 μm (a “Mishoridisk” produced by Tosoh Corporation). Moreover, the sample solution is adjusted so that the concentration of chloroform-soluble components is 1.0 mass %. Measurements are carried out using this sample solution under the following conditions.
Apparatus: LC-Sakura NEXT (Japan Analytical Industry Co., Ltd.)
Column: JAIGEL 2H, 4H (Japan Analytical Industry Co., Ltd.)
Eluant: Chloroform
Flow rate: 10.0 mL/min
Oven temperature: 40.0° C.
Injected amount: 1.0 mL

When calculating the molecular weight of the sample, a molecular weight calibration curve is prepared using standard polystyrene resins (for example, product names “TSK Standard Polystyrene F-850, F-450, F-288, F-128, F-80, F-40, F-20, F-10, F-4, F-2, F-1, A-5000, A-2500, A-1000 and A-500”, produced by Tosoh Corporation).

The release agent is removed from the toner by repeatedly isolating components having molecular weights of 2000 or less from the thus obtained molecular weight curve.

Method for Measuring Content Ratio of Various Monomer Units in Resin

The content ratio of various monomer units in the resin is measured by ¹H-NMR under the following conditions.
Measuring device: FT NMR device JNM-EX400 (manufactured by JEOL Ltd.)
Measurement frequency: 400 MHz
Pulse condition: 5.0 s
Frequency range: 10,500 Hz
Cumulative number: 64 times
Measurement temperature: 30° C.

Sample: 50 mg of a measurement sample is placed in a sample tube having an internal diameter of 5 mm, deuterated chloroform (CDCl₃) is added as a solvent, and the measurement sample is dissolved in a constant temperature bath at 40° C. The obtained ¹H-NMR chart is analyzed and the structures of the monomer units are identified. As an example, measurement of the content of the monomer unit (a) in the resin A will now be described. From among peaks attributable to constituent elements of the monomer unit (a) in an obtained ¹H-NMR chart, a peak that is independent from peaks attributable to constituent elements of other monomer units is selected, and the integrated value S1 of this peak is calculated. Integrated values are calculated in the same way for other monomer units contained in the resin A.

In a case where monomer units that constitute the resin A are the monomer unit (a) and one other monomer unit, the content of the monomer unit (a) is determined in the manner shown below using the integrated value S1 above and an integrated value S2 of the other monomer unit. Moreover, n1 and n2 denote the number of hydrogens in constituent elements attributable to peaks observed for the respective segments.

Content (mol %) of monomer unit (a)={(S1/n1)/((S1/n1)+(S2/n2))}×100

In cases where the number of other monomer units is 2 or more, the content of the monomer unit (a) can be calculated in the same way.

Moreover, in cases where a polymerizable monomer in which hydrogen is not contained in constituent elements other than vinyl groups is used, ¹³C-NMR measurements are carried out in single pulse mode using ¹³C as a measurement atomic nucleus, and calculations are carried out in the same way as in ¹H-NMR measurements. Content values of monomer units can be converted into mass percentages by multiplying the proportions (mol %) of the monomer units, which have been calculated using the method described above, by the molecular weights of these monomer units.

In addition, in a case where NMR measurements are carried out using the toner as a sample, peaks for waxes and resins other than the resin A may overlap, and independent peaks may not be observed. As a result, it may not be possible to calculate the content of monomer units in the resin A. In such cases, it is possible to produce a resin A′ in the same way, but without using waxes or other resins, and analyze the resin A′ in the same way as the resin A. The resin B is measured using a similar method.

Method for Measuring Weight Average Molecular Weight (Mw) of Resin The weight average molecular weight (Mw) of a resin is measured by means of gel permeation chromatography (GPC), in the manner described below. First, a sample is dissolved in tetrahydrofuran (THF) at room temperature over a period of 24 hours. A sample solution is then obtained by filtering the obtained solution using a solvent-resistant membrane filter having a pore diameter of 0.2 μm (a “Mishoridisk” produced by Tosoh Corporation). Moreover, the sample solution is adjusted so that the concentration of TIF-soluble components is 0.8 mass %. Measurements are carried out using this sample solution under the following conditions.

Apparatus: HLC8120 GPC (detector: RI) (produced by Tosoh Corporation)
Column: Combination of Shodex KF-801, 802, 803, 804, 805, 806 and 807 (produced

### by Showa Denko Kabushiki Kaisha)

### Eluant: Tetrahydrofuran (THF)

Flow rate: 1.0 mL/min
Oven temperature: 40.0° C.
Injected amount: 0.10 mL

A molecular weight calibration curve prepared using standard polystyrene resin (for example, product name: TSK standard polystyrene F-850, F-450, F-288, F-128, F-80, F-40, F-20, F-10, F-4, F-2, F-1, A-5000, A-2500, A-1000, A-500, Tosoh Corp.) is used for calculating the molecular weights of the samples.

Method for Measuring Endothermic Peak Temperature and Endothermic

### Quantity

The endothermic peak temperature (melting point) and endothermic amount of a toner or resin are measured using a DSC Q2000 (produced by TA Instruments) under the following conditions.

Temperature increase rate: 10° C./min
Measurement start temperature: 20° C.
Measurement end temperature: 180° C.

Temperature calibration of the detector in the apparatus is performed using the melting points of indium and zinc, and heat amount calibration is performed using the heat of fusion of indium. Specifically, 5 mg of a sample is weighed out, placed in an aluminum pan, and subjected to differential scanning calorimetric measurements. An empty silver pan is used as a reference. The temperature is increased to 180° C. at a rate of 10° C./min. Next, peak top temperatures and endothermic quantities are calculated from the peaks.

In DSC measurements using the toner as a sample, in a case where an endothermic peak derived from the resin A does not overlap another endothermic peak, such as one derived from a release agent, the obtained endothermic peak is regarded as an “endothermic peak derived from the resin A”. However, in a case where an endothermic peak of another component such as a release agent overlaps an endothermic peak derived from the resin A, it is essential to separate the endothermic peak derived from the release agent or the like.

For example, it is possible to separate an endothermic peak derived from the release agent and obtain an endothermic peak derived from the resin A using the following method. First, DSC measurements are separately carried out on the release agent in isolation so as to determine the endothermic characteristics thereof. Next, the content of the release agent in the toner is determined. The content of the release agent in the toner can be measured using a well-known structural analysis method. Next, an endothermic peak attributable to the release agent is confirmed from the content of the release agent in the toner, and this amount should be deducted from a peak derived from the resin A.

In a case where the release agent is readily compatible with the resin A, it is essential to multiply the content of the release agent by the degree of compatibility thereof, calculate the endothermic quantity attributable to the release agent, and then subtract this endothermic quantity. The degree of compatibility is calculated from a value obtained by dividing the endothermic quantity, which is determined for a material obtained by melting and mixing equal proportions of the release agent and a molten mixture of resin components, by the theoretical endothermic quantity, which is calculated from the endothermic quantity of the molten mixture and the endothermic quantity of the release agent in isolation, which are determined in advance. The endothermic quantity is calculated by using DSC analysis software to calculate the endothermic quantity from a temperature that is 20.0° C. lower than the corresponding endothermic peak Tp to a temperature that is 10.0° C. higher than this Tp value.

Moreover, in a case where a plurality of endothermic peaks derived from the resin A are present, the peak temperature of a peak having the maximum peak height is “the peak temperature of the largest endothermic peak”, and the total endothermic quantity of the plurality of peaks is “the endothermic quantity of endothermic peaks derived from the resin A”.

### Measurement of Glass Transition Temperature

The glass transition temperature Tg is measured in accordance with ASTM D3418-82 using a “Q2000” differential scanning calorimeter (produced by TA Instruments). Temperature calibration of the detector in the apparatus is performed using the melting points of indium and zinc, and heat amount calibration is performed using the heat of fusion of indium. Specifically, 2 mg of a sample is precisely weighed out and placed in an aluminum pan, an empty aluminum pan is used as a reference, and measurements are carried out within a measurement temperature range of −10 to 200° C., at a ramp rate of 10° C./min. Moreover, when carrying out measurements, the temperature is once increased to 200° C., then lowered to −10° C., and then increased again. A change in specific heat is determined within the temperature range of 30 to 100° C. in this 2nd temperature increase step. Here, the glass transition temperature Tg is deemed to be the point at which the differential thermal analysis curve intersects with the line at an intermediate point on the baseline before and after a change in specific heat occurs.

Measurement of Weight-Average Particle Diameter (D4) of Toner

The weight-average particle diameter (D4) of the toner is calculated in the manner described below. An apparatus for precisely measuring particle size distribution using a pore electrical resistance method, which is provided with a tube having an aperture of 100 μm (a Coulter Counter Multisizer 3 (registered trademark) produced by Beckman Coulter, Inc.) is used as the measurement apparatus. Settings for measurement conditions and analysis of measured data are carried out using dedicated software for the measurement apparatus (Beckman Coulter Multisizer 3 Version 3.51 produced by Beckman Coulter, Inc.). Moreover, measurements are carried out using 25,000 effective measurement channels. A solution obtained by dissolving special grade sodium chloride in ion exchanged water at a concentration of 1.0 mass %, such as “ISOTON II” (produced by Beckman Coulter), can be used as an aqueous electrolyte solution used in the measurements.

Moreover, dedicated software was set up as follows before carrying out measurements and analysis. On the “Standard Operating Method (SOMME) alteration” screen in the dedicated software, the total count number in control mode is set to 50,000 particles, the number of measurements is set to 1, and the Kd value is set to “standard particle 10.0 μm” (Beckman Coulter). By pressing the “Threshold value/noise level measurement button”, threshold values and noise levels are automatically set. In addition, the current is set to 1600 μA, the gain is set to 2, the electrolyte solution is set to ISOTON II, and the “Flush aperture tube after measurement” option is checked. On the “Conversion settings from pulse to particle diameter” screen in the dedicated software, the bin interval is set to logarithmic particle diameter, the particle diameter bin is set to 256 particle diameter bin, and the particle diameter range is set to from 2 μm to 60 μm. The specific measurement method is as follows.

(1) 200.0 mL of the aqueous electrolyte solution is placed in a Multisizer 3 dedicated 250 mL glass round bottomed beaker, the beaker is set on a sample stand, and a stirring rod is rotated anticlockwise at a rate of 24 rotations/second. By carrying out the “Aperture tube flush” function of the dedicated software, dirt and bubbles in the aperture tube are removed.

(2) 30.0 mL of the aqueous electrolyte solution is placed in a 100 mL glass flat bottomed beaker. Approximately 0.3 mL of a diluted liquid, which is obtained by diluting “Contaminon N” (a 10% aqueous solution of a neutral detergent for cleaning precision measurement equipment, which has a pH of 7 and comprises a non-ionic surfactant, an anionic surfactant and an organic builder, produced by Wako Pure Chemical Industries, Ltd.) 3-fold with deionized water, is added to the beaker as a dispersant.

(3) An ultrasonic wave disperser (Ultrasonic Dispersion System Tetra 150 produced by Nikkaki Bios Co., Ltd.) having an electrical output of 120 W, in which 2 oscillators having an oscillation frequency of 50 kHz are housed so that their phases are staggered by 180° is prepared. 3.3 L of ion exchanged water is placed in a water bath in the ultrasonic dispersion system, and 2.0 mL of Contaminon N is added to this water bath.

(4) The beaker mentioned in step (2) above is placed in a beaker-fixing hole in the ultrasonic wave disperser, and the ultrasonic wave disperser is activated. The height of the beaker is adjusted so that the resonant state of the liquid surface of the aqueous electrolyte solution in the beaker is at a maximum.

(5) While the aqueous electrolyte solution in the beaker mentioned in section (4) above is being irradiated with ultrasonic waves, 10 mg of toner particles are added a little at a time to the aqueous electrolyte solution and dispersed therein. The ultrasonic wave dispersion treatment is continued for a further 60 seconds. Moreover, when carrying out the ultrasonic wave dispersion, the temperature of the water bath is adjusted as appropriate to a temperature of from 10° C. to 40° C.

(6) The aqueous electrolyte solution mentioned in section (5) above, in which the toner particles are dispersed, is added dropwise by means of a pipette to the round bottomed beaker mentioned in section (1) above, which is disposed on the sample stand, and the measurement concentration is adjusted to 5%. Measurements are carried out until the number of particles measured reaches 50,000.

(7) The weight-average particle diameter (D4) is calculated by analyzing measurement data using the accompanying dedicated software. Moreover, when setting the graph/vol. % with the dedicated software, the “average diameter” on the “Analysis/volume-based statistical values (arithmetic mean)” screen is weight-average particle diameter (D4).

Measurement of Acid Value of Resin

Acid value is the mass (mg) of potassium hydroxide required to neutralize acid contained in 1 g of a sample. The acid value of a resin, such as the resin A or the resin B, is measured in accordance with JIS K 0070-1992, but is specifically measured using the following procedure.

### (1) Reagent Preparation

A phenolphthalein solution is obtained by dissolving 1.0 g of phenolphthalein in 90 mL of ethyl alcohol (95 vol. %) and adding ion exchanged water up to a volume of 100 mL. 7 g of special grade potassium hydroxide is dissolved in 5 mL of water, and ethyl alcohol (95 vol. %) is added up to a volume of 1 L. A potassium hydroxide solution is obtained by placing the obtained solution in an alkali-resistant container so as not to be in contact with carbon dioxide gas or the like, allowing solution to stand for 3 days, and then filtering. The obtained potassium hydroxide solution is stored in the alkali-resistant container. The factor of the potassium hydroxide solution is determined by placing 25 mL of 0.1 mol/L hydrochloric acid in a conical flask, adding several drops of the phenolphthalein solution, titrating with the potassium hydroxide solution, and determining the factor from the amount of the potassium hydroxide solution required for neutralization. The 0.1 mol/L hydrochloric acid is produced in accordance with JIS K 8001-1998.

(2) Operation

### (A) Main Test

2.0 g of a pulverized sample is measured precisely into a 200 mL conical flask, 100 mL of a mixed toluene/ethanol (2:1) solution is added, and the sample is dissolved over a period of 5 hours. Next, several drops of the phenolphthalein solution are added as an indicator, and titration is carried out using the potassium hydroxide solution. Moreover, the endpoint of the titration is deemed to be the point when the pale crimson color of the indicator is maintained for 30 seconds.

### (B) Blank Test

Titration is carried out in the same way as in the operation described above, except that the sample is not used (that is, only a mixed toluene/ethanol (2:1) solution is used).

(3) The acid value is calculated by inputting the obtained results into the formula below.

A=[(C−B)×f×5.61]/S

Here, A denotes the acid value (mg KOH/g), B denotes the added amount (mL) of the potassium hydroxide solution in the blank test, C denotes the added amount (mL) of the potassium hydroxide solution in the main test, f denotes the factor of the potassium hydroxide solution, and S denotes the mass (g) of the sample.

Method for Calculating SP Value

SP values of monomer units, such as SPa and SPc, are determined in the manner described below in accordance with the calculation method proposed by Fedors. For atoms and atomic groups in a molecular structure in which a double bond in a polymerizable monomer is cleaved by means of polymerization, the evaporation energy (Δei) (cal/mol) and molar volume (Δvi) (cm³/mol) of atoms and atomic groups in the molecular structure are determined from tables shown in “Polym. Eng. Sci., 14(2), 147-154 (1974)”, and (4.184×ΣΔei/ΣΔvi)^{0.5} is taken to be the SP value (J/cm³)^{0.5}.

However, SPA and SPB, which are the SP values of the resins, are obtained by determining the evaporation energy (Δei) and molar volume (Δvi) for each monomer unit that constitutes the resins, calculating the molar ratio (j) of each monomer unit in the resins, dividing the sum of the evaporation energies of the units by the sum of the molar volumes, and calculating using the formula below.

SPs={(Σj×ΣΔei)/(Σj×ΣΔvi)}^{1/2}

The SP value for each resin is calculated in the manner described above. Units for SP values can be converted into units of (cal/cm³)^{0.5} because 1 (cal/cm³)^{0.5}=2.045 (J/cm³)^{0.5}.

### Working Examples

Hereinafter, the present invention will be specifically described with reference to Examples, but these do not limit the present invention in any way. In the following formulations, parts are based on mass unless otherwise specified.

Production Example of Resin B1

In a nitrogen atmosphere, the materials listed below were placed in a reaction vessel equipped with a reflux condenser, a stirrer, a temperature gauge and a nitrogen inlet tube.
Solvent: Toluene: 100.0 parts
Styrene: 64.0 parts
Behenyl acrylate: 18.0 parts
Acrylonitrile: 15.0 parts
Methacrylic acid: 3.0 parts
Polymerization initiator [t-butyl peroxypivalate (Perbutyl PV, produced NOF Corp.)]: 5.0 parts

While being stirred at 200 rpm, the contents of the reaction vessel were heated to 70° C. and a polymerization reaction was carried out for 12 hours, thereby obtaining a solution in which a polymer of the monomer composition was dissolved in toluene. The temperature of the solution was then lowered to 25° C., and the solution was introduced into 1000.0 parts of methanol under stirring, thereby causing methanol-insoluble matter to precipitate. The thus obtained methanol-insoluble components were filtered and washed with methanol, and then vacuum dried at 40° C. for 24 hours, thereby obtaining the resin B1. Physical property values of the resin B1 are shown in Table 1. When the resin B1 was analyzed using NMR and molar percentages were converted to mass percentages, the resin B1 contained 64.0 mass % of monomer units formed by polymerization of styrene, 18.0 mass % of monomer units formed by polymerization of behenyl acrylate, 15.0 mass % of monomer units formed by polymerization of acrylonitrile and 3.0 mass % of monomer units formed by polymerization of methacrylic acid.

Production Examples of Resins B2 to B9 and B12 to B18

Resins B2 to B9 and B12 to B18 were obtained in the same way as in the production method of the resin B1, except that the types and charged amounts of polymerizable monomers were changed to those shown in Table 1. Physical property values are shown in Table 1.

Production Example of Resin B10

The resin B10 was obtained in the same way as in the production method of the resin B1, except that the number of parts of the polymerization initiator (t-butyl peroxypivalate) was changed to 7.0 parts. Physical property values of the resin B10 are shown in Table 1.

Production Example of Resin B11

A resin B11 was obtained in the same way as in the production method of the resin B1, except that the number of parts of the polymerization initiator (t-butyl peroxypivalate) was changed to 3.0 parts. Physical property values of the resin B11 are shown in Table 1.

When the resins B2 to B18 were analyzed using NMR, it was confirmed that the monomer units were present at the same mass ratios as the monomers used, in the same way as the resin B1.

TABLE 1

| | | | | | | | | | Physical properties | | | |
|---|---|---|---|---|---|---|---|---|---|---|---|---|
| | | | | | | | | | | Acid | SP | Tg |
| | Composition [Monomer type/number of parts] | | | | | | | | Mw | value | value | [° C.] |
| Resin B1 | BeA | 18.0 | AN | 15.0 | MAA | 3.0 | St | 64.0 | 17,000 | 16.5 | 21.20 | 58.0 |
| Resin B2 | BeA | 18.0 | AN | 15.0 | MAA | 28.0 | St | 51.0 | 17,000 | 16.5 | 22.33 | 57.0 |
| Resin B3 | StA | 18.0 | AN | 15.0 | MAA | 3.0 | St | 64.0 | 16,500 | 16.5 | 21.22 | 53.0 |
| Resin B4 | MiA | 18.0 | AN | 15.0 | MAA | 3.0 | St | 64.0 | 17,000 | 16.5 | 21.20 | 59.0 |
| Resin B5 | BeA | 5.2 | AN | 15.0 | MAA | 3.0 | St | 76.8 | 18,200 | 16.5 | 21.44 | 72.0 |
| Resin B6 | BeA | 9.0 | AN | 14.0 | MAA | 3.0 | St | 74.0 | 17,800 | 16.5 | 21.28 | 67.0 |
| Resin B7 | BeA | 28.0 | AN | 5.0 | MAA | 3.0 | St | 64.0 | 16,200 | 16.5 | 20.91 | 41.0 |
| Resin B8 | LaA | 18.0 | AN | 15.0 | MAA | 3.0 | St | 64.0 | 17,500 | 16.5 | 21.29 | 58.0 |
| Resin B9 | DcA | 18.0 | AN | 15.0 | MAA | 3.0 | St | 64.0 | 17,500 | 16.5 | 21.33 | 58.0 |
| Resin B10 | BeA | 18.0 | AN | 15.0 | MAA | 3.0 | St | 64.0 | 11,000 | 16.5 | 21.20 | 56.0 |
| Resin B11 | BeA | 18.0 | AN | 15.0 | MAA | 3.0 | St | 64.0 | 19,000 | 16.5 | 21.20 | 60.0 |
| Resin B12 | BeA | 18.0 | AN | 15.0 | MAA | 0.8 | St | 66.2 | 17,000 | 4.5 | 21.09 | 57.5 |
| Resin B13 | BeA | 18.0 | AN | 15.0 | MAA | 1.0 | St | 66.0 | 17,000 | 5.2 | 21.10 | 57.6 |
| Resin B14 | BeA | 18.0 | AN | 15.0 | MAA | 1.8 | St | 65.2 | 17,000 | 10.0 | 21.13 | 58.0 |
| Resin B15 | BeA | 18.0 | AN | 15.0 | MAA | 4.5 | St | 62.5 | 16,800 | 25.0 | 21.26 | 56.9 |
| Resin B16 | BeA | 18.0 | AN | 15.0 | MAA | 5.8 | St | 61.2 | 16,700 | 32.0 | 21.32 | 57.7 |
| Resin B17 | BeA | 18.0 | HEMA | 15.0 | MAA | 3.0 | St | 64.0 | 16,400 | 16.5 | 20.64 | 57.0 |

Table 1 Composition and physical properties of resin B

In the table, units for acid value are mg KOH/g, and units for SP value are (J/cm³)^{0.5}.

From here onwards, abbreviations used in the tables are as follows.
BeA: Behenyl acrylate (number of carbon atoms (m): 22)
AN: Acrylonitrile
MAA: Methacrylic acid
St: Styrene
StA: Stearyl acrylate (number of carbon atoms (m): 17)
MiA: Myricyl acrylate (number of carbon atoms (m): 29)
LaA: Lauryl acrylate (number of carbon atoms (m): 11)
DcA: Decyl acrylate (number of carbon atoms (m): 9)
HEMA: 2-hydroxyethyl methacrylate

Production Example of Amorphous Resin 1

Amorphous resin 1 was obtained in the same way as in the production method of the resin B1, except that the materials placed in the reactor were changed as follows.
Solvent: Toluene: 100.0 parts
Styrene: 64.0 parts
n-butyl acrylate: 36.0 parts
Polymerization initiator [t-butyl peroxypivalate (Perbutyl PV, produced NOF Corp.)]: 5.0 parts

Production Example of Toner 1

### Production of Toner by Suspension Polymerization

### Preparation of Toner Particle 1

The materials listed below were placed in an attritor (produced by Nippon Coke and Engineering Co., Ltd.).
Methacrylonitrile: 28.8 parts
Styrene: 6.7 parts
Ethyl methacrylate: 12.5 parts
Coloring agent: Pigment Blue 15:3: 6.0 parts

A raw material-dispersed solution was obtained by dispersing these materials for 2 hours at 200 rpm using zirconia beads having diameters of 5 mm.

Meanwhile, 735.0 parts of ion exchanged water and 16.0 parts of trisodium phosphate dodecahydrate were placed in a vessel equipped with a high-speed stirrer (a homomixer produced by Primix Corporation) and a temperature gauge, and the temperature was increased to 60° C. while stirring at 12,000 rpm. Next, an aqueous solution of calcium chloride, which was obtained by dissolving 9.0 parts of calcium chloride dihydrate in 65.0 parts of ion exchanged water, was placed in the vessel and stirred for 30 minutes at 12,000 rpm while maintaining a temperature of 60° C., thereby obtaining an aqueous medium in which a hydroxyapatite-containing dispersion stabilizer was dispersed in water.

The raw material-dispersed solution was then transferred to a vessel equipped with a stirrer and a temperature gauge, and the temperature was increased to 60° C. while stirring at 100 rpm. The following materials were then placed in the vessel.
Behenyl acrylate: 48.2 parts
Resin B1: 3.8 parts
Wax: Dipentaerythritol hexastearate: 9.0 parts
   After stirring for 30 minutes at 100 rpm while maintaining a temperature of 60° C., 5.0 parts of t-butyl peroxypivalate (Perbutyl PV produced by NOF Corp.) was then added as a polymerization initiator, stirring was carried out for a further 1 minute, and the solution was then introduced into an aqueous medium being stirred at 12,000 rpm using the high-speed stirrer. A granulation solution was obtained by continuing the stirring for 20 minutes at 12,000 rpm using the high-speed stirrer while maintaining a temperature of 60° C.

The granulation solution was transferred to a reaction vessel equipped with a reflux condenser tube, a stirrer, a temperature gauge and a nitrogen inlet tube, and the temperature was increased to 70° C. while stirring at 150 rpm in a nitrogen atmosphere. A toner particle-dispersed solution was obtained by carrying out a polymerization reaction for 12 hours while stirring at 150 rpm and maintaining a temperature of 70° C. The obtained toner particle-dispersed solution was cooled to 45° C. while being stirred at 150 rpm and then heat treated for 5 hours while maintaining a temperature of 45° C. Following the heat treatment, the toner particle-dispersed solution was cooled to 30° C., and dilute hydrochloric acid was added under stirring until the pH reached 1.5, thereby dissolving the dispersion stabilizer. Solid content was filtered off, thoroughly washed with ion exchanged water and then vacuum dried for 24 hours at 30° C., thereby obtaining toner particle 1, which contained the resin A1.

In addition, a resin A1′ was obtained in the same way as in the method for producing toner particle 1, except that Pigment Blue 15:3, the resin B and a wax were not used. The resin A1′ had a weight average molecular weight (Mw) of 56,000, a melting point of 63° C., and an acid value of 0.0 mg KOH/g. When analyzed using NMR, the resin A1′ contained 50.0 mass % of monomer units formed by polymerization of behenyl acrylate, 30.0 mass % of monomer units formed by polymerization of acrylonitrile, 7.0 mass % of monomer units formed by polymerization of styrene and 13.0 mass % of monomer units formed by polymerization of ethyl methacrylate. It was confirmed that the resin A, which was obtained by being separated from the toner using the method described above, and this resin A′ had similar physical properties. In addition, it was confirmed that the resin B, which was obtained by being separated from the toner using the method described above, and the resin B1, which was used as a raw material, had similar physical properties.

Toner 1 was obtained by adding 2.0 parts of silica fine particles (treated with dimethylsilicone; number average particle diameter of primary particles: 10 nm) as an external additive to 100.0 parts of toner particle 1, and mixing for 15 minutes at 3000 rpm using an FM mixer (produced by Nippon Coke and Engineering Co., Ltd.).

The resin A and the resin B were separated from Toner 1 using the method described above, and physical properties of the obtained resins were measured. Physical properties are shown in Table 5, and evaluation results are shown in Table 6.

Production Examples of Toners 2 to 30

Toner particles 2 to 30 were obtained in the same way as the production example of Toner 1, except that types and added quantities of monomers used, the type and added quantity of the resin B, and types and added quantities of other additives were changed as shown in Table 2. Toners 2 to 30 were then obtained by carrying out external addition in the same way as for Toner 1. Physical properties of the toner are shown in Table 5, and evaluation results are shown in Table 6. For Toner 28, the resin A′ was prepared in the same way as for the resin A1′ described above, and physical properties were measured and taken to be physical properties of the resin A.

TABLE 2

| | Polynnerizable monomers for forming resin A | | | | | | | | | | Other added | |
|---|---|---|---|---|---|---|---|---|---|---|---|---|
| | Monomer (a) | | Monomer (c) | | | | | | | | resin | |
| | for forming | | for forming | | Monomer for | | | | | | (amorphous | |
| | unit (a) | | unit (c) | | forming other unit | | | | Resin B | | resin) | |
| | Type | Parts | Type | Parts | Type | Parts | Type | Parts | No. | Parts | No. | Parts |
| Toner 1 | BeA | 48.1 | MAN | 28.9 | St | 6.7 | EMA | 12.5 | 1 | 3.8 | — | — |
| Toner 2 | BeA | 48.1 | MAN | 28.9 | St | 6.7 | EMA | 12.5 | 2 | 3.8 | — | — |
| Toner 3 | StA | 48.1 | MAN | 28.9 | St | 6.7 | EMA | 12.5 | 3 | 3.8 | — | — |
| Toner 4 | MiA | 48.1 | MAN | 28.9 | St | 6.7 | EMA | 12.5 | 4 | 3.8 | — | — |
| Toner 5 | BeA | 40.5 | MAN | 28.8 | St | 9.6 | EMA | 17.3 | 1 | 3.8 | — | — |
| Toner 6 | BeA | 66.0 | MAN | 14.0 | St | 5.4 | EMA | 10.8 | 1 | 3.8 | — | — |
| Toner 7 | BeA | 48.1 | MAN | 28.9 | St | 6.7 | EMA | 12.5 | 5 | 3.8 | — | — |
| Toner 8 | BeA | 48.1 | MAN | 28.9 | St | 6.7 | EMA | 12.5 | 6 | 3.8 | — | — |
| Toner 9 | BeA | 48.1 | MAN | 28.9 | St | 6.7 | EMA | 12.5 | 7 | 3.8 | — | — |
| Toner 10 | BeA | 48.1 | MAN | 28.9 | St | 6.7 | EMA | 12.5 | 8 | 3.8 | — | — |
| Toner 11 | BeA | 48.1 | MAN | 28.9 | St | 6.7 | EMA | 12.5 | 9 | 3.8 | — | — |
| Toner 12 | BeA | 49.4 | MAN | 29.6 | St | 6.9 | EMA | 12.8 | 1 | 1.3 | — | — |
| Toner 13 | BeA | 44.2 | MAN | 26.6 | St | 6.2 | EMA | 11.5 | 1 | 11.5 | — | — |
| Toner 14 | BeA | 41.3 | MAN | 24.8 | St | 5.8 | EMA | 10.8 | 1 | 17.3 | — | — |
| Toner 15 | BeA | 37.8 | MAN | 22.8 | St | 5.3 | EMA | 9.9 | 1 | 24.2 | — | — |
| Toner 16 | BeA | 48.2 | MAN | 17.3 | St | 10.6 | EMA | 20.2 | 1 | 3.8 | — | — |
| Toner 17 | BeA | 48.2 | MAN | 21.2 | St | 9.6 | EMA | 17.3 | 1 | 3.8 | — | — |
| Toner 18 | BeA | 48.1 | VA | 28.9 | St | 6.7 | EMA | 12.5 | 1 | 3.8 | — | — |
| Toner 19 | BeA | 48.1 | AAD | 28.9 | St | 6.7 | EMA | 12.5 | 1 | 3.8 | — | — |
| Toner 20 | BeA | 48.1 | MAN | 28.9 | St | 6.7 | EMA | 12.5 | 10 | 3.8 | — | — |
| Toner 21 | BeA | 48.1 | MAN | 28.9 | St | 6.7 | EMA | 12.5 | 11 | 3.8 | — | — |
| Toner 22 | BeA | 48.1 | MAN | 28.9 | St | 6.7 | EMA | 12.5 | 12 | 3.8 | — | — |
| Toner 23 | BeA | 48.1 | MAN | 28.9 | St | 6.7 | EMA | 12.5 | 13 | 3.8 | — | — |
| Toner 24 | BeA | 48.1 | MAN | 28.9 | St | 6.7 | EMA | 12.5 | 14 | 3.8 | — | — |
| Toner 25 | BeA | 48.1 | MAN | 28.9 | St | 6.7 | EMA | 12.5 | 15 | 3.8 | — | — |
| Toner 26 | BeA | 48.1 | MAN | 28.9 | St | 6.7 | EMA | 12.5 | 16 | 3.8 | — | — |
| Toner 27 | BeA | 48.2 | MAN | 27.8 | St | 6.7 | EMA | 12.5 | 1 | 3.8 | — | — |
| | | | MAA | 1.0 | | | | | | | | |
| Toner 28 | BeA | 43.3 | MAN | 26.0 | St | 6.1 | EMA | 11.3 | 1 | 3.4 | 1 | 9.9 |
| Toner 29 | BeA | 48.1 | MAN | 28.9 | St | 6.7 | EMA | 12.5 | 17 | 3.8 | — | — |
| Toner 30 | BeA | 48.1 | MAN | 28.9 | St | 19.2 | | | 1 | 3.8 | — | — |

Abbreviations used in the tables are as follows. Other abbreviations are as shown in Table 1.
MAN: Methacrylonitrile
VA: Vinyl acetate
AD: Acrylamide

Production Example of Toner 31

### Production Example of Resin A31

In a nitrogen atmosphere, the materials listed below were placed in a reaction vessel equipped with a reflux condenser, a stirrer, a temperature gauge and a nitrogen inlet tube.
Toluene: 100.0 parts
Behenyl acrylate: 50.0 parts
Methacrylonitrile: 30.0 parts
Ethyl methacrylate: 13.0 parts
Styrene: 7.0 parts
t-butyl peroxypivalate (Perbutyl PV, produced NOF Corp.): 0.5 parts

While being stirred at 200 rpm, the contents of the reaction vessel were heated to 70° C. and a polymerization reaction was carried out for 12 hours, thereby obtaining a solution in which a polymer of the monomer composition was dissolved in toluene. The temperature of the obtained solution was then lowered to 25° C., and the solution was introduced into 1000.0 parts of methanol under stirring, thereby causing methanol-insoluble components to precipitate. The thus obtained methanol-insoluble components were filtered and washed with methanol, and then vacuum dried at 40° C. for 24 hours, thereby obtaining the resin A31.

Production of Toner by Pulverization Method
Resin A31: 96.2 parts
Resin B1: 3.8 parts
Coloring agent: Pigment Blue (Dainichiseika Color and Chemicals Mfg. Co., Ltd.) 15:3: 6.0 parts
Wax: Dipentaerythritol hexastearate: 9.0 parts
Charge control agent (LR147 produced by Japan Carlit Co., Ltd.): 2.0 parts

The materials listed above were pre-mixed using an FM mixer (produced by Nippon Coke & Engineering Co., Ltd.), and then melt kneaded at 150° C. using a twin screw kneading extruder (PCM-30 produced by Ikegai Corporation) to obtain a melt-kneaded product. In a process for cooling the obtained kneaded product, a heat treatment was carried out by maintaining a temperature of 45° C. for 5 hours. Following the heat treatment, the kneaded product was coarsely pulverized using a hammer mill and then pulverized using a mechanical pulverizer (a T-250, produced by Freund Turbo Corporation). The obtained finely pulverized powder was classified using a multiple section sorting apparatus using the Coanda effect, thereby obtaining toner particle 31, which had a weight average particle diameter (D4) of 7.0 μm.

Toner 33 was obtained by adding 2.0 parts of silica fine particles (hydrophobically treated with hexamethyldisilazane; number average particle diameter of primary particles: 10 nm) as an external additive to 100.0 parts of toner particle 31, and mixing for 15 minutes at 3000 rpm using an FM mixer (produced by Nippon Coke and Engineering Co., Ltd.). Physical properties of Toner 31 are shown in Table 5, and evaluation results are shown in Table 6.

Production Example of Toner 32

### Production of Toner by Suspension Aggregation

### Preparation of Resin A31-Dispersed Solution

Toluene: 300.0 parts
Resin A31: 100.0 parts

A toluene solution was obtained by weighing out and mixing the materials listed above, and dissolving the resin A31 at 90° C. Separately, 5.0 parts of sodium dodecylbenzene sulfonate and 10.0 parts of sodium laurate were added to 700.0 parts of ion exchanged water, and dissolved by heating at 90° C. to obtain an aqueous solution. Next, the toluene solution and aqueous solution mentioned above were mixed together and stirred at 7000 rpm using a T.K. Robomix ultrahigh speed stirrer (produced by Primix Corporation). The obtained mixture was then emulsified at a pressure of 200 MPa using a Nanomizer high pressure impact disperser (produced by Yoshida Kikai Co., Ltd.). A dispersed solution containing fine particles of the resin A31 at a concentration of 20 mass % was then obtained by removing the toluene using an evaporator and adjusting the concentration by means of ion exchanged water. The 50% particle diameter on a volume basis (D50) of the resin A31-dispersed solution was measured and found to be 0.40 μm.

Preparation of Resin B1-Dispersed Solution

A resin B1-dispersed solution, which contained 20 mass % of fine particles of the resin B1, was obtained in the same way as in the preparation of the resin A31-dispersed solution, except that the resin A31 was replaced with the resin B1. The 50% particle diameter on a volume basis (D50) of the resin B1-dispersed solution was measured and found to be 0.38 μm.

Preparation of Wax-Dispersed Solution 1
Wax (dipentaerythritol hexastearate): 100.0 parts
Anionic surfactant (Neogen RK produced by Dai-ichi Kogyo Seiyaku Co., Ltd.): 5.0 parts
Ion exchanged water: 395.0 parts

The materials listed above were placed in a mixing vessel equipped with a stirring device, and heated to 90° C. The materials were then subjected to dispersion treatment for 60 minutes by being circulated in a Clearmix W-Motion (produced by M Technique Co., Ltd.). The dispersion treatment conditions were as follows.
Outer diameter of rotor: 3 cm
Clearance: 0.3 mm
Rotational speed of rotor: 19,000 rpm
Rotational speed of screen: 19,000 rpm

Following the dispersion treatment, a wax-dispersed solution 1 in which the content of wax fine particles was 20 mass % was obtained by cooling to 40° C. at a rotor rotational speed of 1000 rpm, a screen rotational speed of 0 rpm and a cooling rate of 10° C./min. The 50% particle diameter on a volume basis (D50) of the wax fine particles was measured and found to be 0.15 μm.

Preparation of Colorant-Dispersed Solution 1
Coloring agent (Pigment Blue 15:3): 50.0 parts
Anionic surfactant (Neogen RK produced by Dai-ichi Kogyo Seiyaku Co., Ltd.): 7.5 parts
Ion exchanged water: 442.5 parts

A colorant-dispersed solution 1 containing 10 mass % of colorant fine particles was obtained by weighing out, mixing and dissolving the materials listed above and dispersing for 1 hour using a Nanomizer high pressure impact disperser (produced by Yoshida Kikai Co., Ltd.) so as to disperse the colorant. The 50% particle diameter on a volume basis (D50) of the colorant fine particles was measured and found to be 0.20 μm.

Preparation of Toner 32

The materials listed below were placed in a round stainless steel flask and mixed.
Resin A31-dispersed solution: 480.0 parts
Resin B1-dispersed solution: 20.0 parts
Wax-dispersed solution 1: 45.0 parts
Colorant-dispersed solution 1: 60.0 parts
Ion exchanged water: 160.0 parts

Following the mixing, the obtained solution was dispersed for 10 minutes at 5000 rpm using a homogenizer (Ultratarax T50 produced by IKA). A 1.0% aqueous solution of nitric acid was added to adjust the pH to 3.0, and the mixed solution was then heated to 58° C. in a heating water bath while appropriately adjusting the speed of rotation of a stirring blade so that the mixed solution was stirred. The formed aggregated particles were appropriately confirmed, and when aggregated particles having a weight average particle diameter (D4) of 6.0 μm were formed, the pH was adjusted to 9.0 by adding a 5% aqueous solution of sodium hydroxide. The solution was then heated to 75° C. while continuing the stirring. The aggregated particles were fused together by maintaining a temperature of 75° C. for 1 hour.

Next, a heat treatment was carried out by increasing the temperature to 90° C., maintaining a temperature of 90° C. for 1 hour, and then maintaining a temperature of 70° C. for 3 hours. Following the heat treatment, the mixture was then cooled to 30° C., filtered, subjected to solid-liquid separation, and then washed with ion exchanged water. Following completion of the washing, toner particles 32 having a weight-average particle diameter (D4) of 6.1 μm were obtained by drying with a vacuum dryer.

Toner 32 was obtained by adding 2.0 parts of silica fine particles (treated with dimethylsilicone; number average particle diameter of primary particles: 10 nm) as an external additive to 100.0 parts of toner particle 32, and mixing for 15 minutes at 3000 rpm using an FM mixer (produced by Nippon Coke and Engineering Co., Ltd.). Physical properties of Toner 32 are shown in Table 5, and evaluation results are shown in Table 6.

Preparation Examples of Comparative Resins B1, B3, B5 and B6

Comparative resins B1, B3, B5 and B6 were obtained in the same way as in the method for producing the resin B1, except that the types and added quantities (parts by mass) of polymerizable monomers were altered in the manner shown in Table 3. Physical property values are shown in Table 3.

Production Example of Comparative Resin B2

The materials listed below were added to an autoclave equipped with a depressurization device, a water separation device, a nitrogen gas inlet device, a temperature measurement device and a stirrer.
Terephthalic acid: 32.3 parts
Adduct of 2 moles of propylene oxide to bisphenol A: 67.7 parts
Titanium potassium oxalate (catalyst): 0.02 parts

Next, a reaction was carried out in a nitrogen atmosphere at normal pressure and a temperature of 220° C. until a prescribed molecular weight was attained. A comparative resin B2 was obtained by cooling and then pulverizing. Physical property values of the comparative resin B2 are shown in Table 3.

Production Example of Comparative Resin B4

The following raw materials were placed in a heated and dried two-necked flask while introducing nitrogen.
Polyoxypropylene(2.2)-2,2-bis(4-hydroxyphenyl)propane: 30.0 parts
Polyoxyethylene(2.2)-2,2-bis(4-hydroxyphenyl)propane: 33.0 parts
Terephthalic acid: 21.0 parts
Dodecenylsuccinic acid: 15.0 parts
Dibutyltin oxide: 0.1 parts

After purging the system with nitrogen by means of a depressurization procedure, stirring was carried out at 215° C. for 5 hours. The temperature was then slowly increased to 230° C. under reduced pressure while continuing the stirring, and this temperature was then maintained for a further 2 hours. When a viscous state was reached, the system was cooled and the reaction was terminated, thereby synthesizing an amorphous resin that was an amorphous polyester. Physical property values of the comparative resin B4 are shown in Table 3.

TABLE 3-1

| | Composition [Monomer type/number of parts] | | | | | | | | | |
|---|---|---|---|---|---|---|---|---|---|---|
| | Monomer | | | | | | | | | |
| | (b) for | | | | | | | | | |
| Comparative | forming | | | | | | | | | |
| resin B | unit (b) | | Monomer 1 | | Monomer 2 | | Monomer 3 | | Monomer 4 | |
| No. | Type | Parts | Type | Parts | Type | Parts | Type | Parts | Type | Parts |
| B1 | — | — | AN | 15.0 | MAA | 3.0 | St | 89.0 | — | — |
| B2 | — | — | Terephthalic | 32.3 | BPA-PO 2 | 67.7 | — | — | — | — |
| | | | acid | | mole adduct | | | | | |
| B3 | — | — | MMA | 2.5 | MAA | 1.7 | St | 80.9 | BA | 14.9 |
| B4 | — | — | Terephthalic | | Polyoxypropylene- | | Polyoxyethylene- | 33.0 | Dodecenyl- | 15.0 |
| | | | acid | | (2.2)-2,2-bis- | | (2.2)-2,2-bis- | | succinic | |
| | | | | 21.0 | (4-hydroxyphenyl)- | 30.0 | (4-hydroxyphenyl)- | | acid | |
| | | | | | propane | | propane | | | |
| B5 | BeA | 4.0 | AN | 15.0 | MM | 3.0 | St | 78.0 | — | — |
| B6 | CeA | 18.0 | AN | 15.0 | MM | 3.0 | St | 64.0 | — | — |

Abbreviations used in the tables are as follows.

BPA-PO 2 mole adduct: Adduct of 2 moles of propylene oxide to bisphenol A
CeA: Cetyl acrylate (16 carbon atoms)

TABLE 3-2

| | Physical properties | | | |
|---|---|---|---|---|
| | | Acid value | SP value | Tg |
| | Mw | [mgKOH/g] | [(J/cm³)^{0.5}] | [° C.] |
| Comparative resin B1 | 17,000 | 16.5 | 21.50 | 93.0 |
| Comparative resin B2 | 15,200 | 5.1 | 22.30 | 70.0 |
| Comparative resin B3 | 15,000 | 11.0 | 20.17 | 65.0 |
| Comparative resin B4 | 23,000 | 3.0 | 22.18 | 55.0 |
| Comparative resin B5 | 18,000 | 16.5 | 21.47 | 64.0 |
| Comparative resin B6 | 17,000 | 16.5 | 21.06 | 50.0 |

Production Examples of Comparative Toners 1, 2 and 5 to 8

Comparative Toner Particles 1, 2 and 5 to 8 were obtained in the same way as the production example of toner 1, except that types and added quantities of monomers used and the type and added quantity of the comparative resin B, were changed as shown in Table 4. Comparative Toners 1, 2 and 5 to 8 were then obtained by carrying out external addition in the same way as for Toner 1. Physical properties of the toner are shown in Table 5, and evaluation results are shown in Table 6.

TABLE 4

| | Polymerizable monomers for forming resin A | | | | | | | | | |
|---|---|---|---|---|---|---|---|---|---|---|
| | Monomer (a) | | Monomer (c) | | | | | | Comparative | |
| | for forming | | for forming | | Monomer | | | | resin | |
| | unit (a) | | unit (c) | | for forming other unit | | | | B | |
| | | Parts | | Parts | | Parts | | Parts | | Parts |
| | | by | | by | | by | | by | | by |
| | Type | mass | Type | mass | Type | mass | Type | mass | No. | mass |
| Comparative | BeA | 48.2 | MAN | 28.8 | St | 6.7 | EMA | 12.5 | 1 | 3.8 |
| toner | | | | | | | | | | |
| 1 | | | | | | | | | | |
| Comparative | BeA | 48.2 | MAN | 28.8 | St | 6.7 | EMA | 12.5 | 2 | 3.8 |
| toner | | | | | | | | | | |
| 2 | | | | | | | | | | |
| Comparative | BeA | 63.6 | — | — | BMA | 27.3 | — | — | 3 | 9.1 |
| toner | | | | | | | | | | |
| 3 | | | | | | | | | | |
| Comparative | BeA | 63.1 | MAN | 20.7 | St | 10.4 | — | — | 4 | 3.8 |
| toner | | | | | | | | | | |
| 4 | | | | | | | | | | |
| Comparative | BeA | 48.2 | MAN | 28.8 | St | 6.7 | EMA | 12.5 | 5 | 3.8 |
| toner | | | | | | | | | | |
| 5 | | | | | | | | | | |
| Comparative | SeA | 48.2 | MAN | 28.8 | St | 6.7 | EMA | 12.5 | 6 | 3.8 |
| toner | | | | | | | | | | |
| 6 | | | | | | | | | | |
| Comparative | BeA | 78.8 | MAN | 14.4 | St | 1.0 | EMA | 1.9 | B1 | 3.8 |
| toner | | | | | | | | | | |
| 7 | | | | | | | | | | |
| Comparative | BeA | 33.7 | MAN | 28.8 | St | 11.5 | EMA | 22.1 | B1 | 3.8 |
| toner | | | | | | | | | | |
| 8 | | | | | | | | | | |

In the table, the number of the comparative resin B shows the number of the comparative resin used, but the resin B1 shown in Table 1 was used in Comparative Toners 7 and 8.

BMA: Butyl methacrylate

Production Example of Comparative Toner 3
Behenyl acrylate: 63.6 parts
Butyl methacrylate: 27.3 parts
1,10-decane diol diacrylate (crosslinking agent): 0.7 parts
Pigment Blue 15:3: 6.5 parts
Aluminum salicylate compound: 1.0 parts
Paraffin wax: 9.0 parts
   (HNP-51 produced by Nippon Seiro Co., Ltd.; melting point 74° C.)
Comparative resin B3: 9.1 parts
Toluene: 100.0 parts

A monomer mixture comprising the materials listed above was prepared. A monomer composition was obtained by placing 15 mm zirconia beads in this monomer mixture and dispersing for 2 hours using an attritor (produced by Mitsui Miike Kakoki Corporation). In addition, 800 parts of ion exchanged water and 15.5 parts of tricalcium phosphate were added to a container equipped with a high-speed stirrer (a TK-Homomixer produced by Tokushu Kika Kogyo Co., Ltd.), the speed of rotation was adjusted to 15,000 rpm, the temperature was increased to 70° C. and a dispersion medium system was formed. 6.0 parts of t-butyl peroxypivalate was added to the monomer composition as a polymerization initiator, and this was introduced into the dispersion medium system. A granulating step was carried out for 20 minutes while maintaining a speed of rotation of 12,000 rpm in the high-speed stirrer. Next, the stirring machine was changed from the high-speed stirrer to a propeller type stirring blade, polymerization was carried out for 10 hours while maintaining a speed of rotation of 150 rpm and a temperature of 70° C., and desolvation was then carried out for 5 hours at 95° C.

The obtained toner particle-dispersed solution was cooled to 20° C., and dilute hydrochloric acid was then added until the pH reached 1.5. Comparative toner particles 3 were then obtained by thoroughly washing the slurry with ion exchanged water, filtering and drying. Comparative Toner 3 was then obtained by carrying out external addition in the same way as for Toner 1.

Production Example of Comparative Toner 4
Behenyl acrylate: 63.1 parts
Methacrylonitrile: 20.7 parts
Styrene: 10.4 parts
Polypropylene glycol diacrylate: 1.9 parts
   (APG-400 produced by Shin Nakamura Chemical Co., Ltd.; molecular weight 536)
Pigment Blue 15:3: 6.5 parts
Aluminum di-t-butyl salicylate: 1.0 parts
Fischer Tropsch wax: 20.0 parts (HNP-51, produced by Nippon Seiro Co., Ltd., melting point (Tm): 74° C.)
Comparative resin B4: 3.8 parts
Toluene: 100.0 parts

A mixture comprising the materials listed above was prepared. A raw material-dispersed solution was obtained by placing the mixture in an attritor (produced by Nippon Coke & Engineering Co., Ltd.) and dispersing for 2 hours at 200 rpm using zirconia beads having diameters of 5 mm. Meanwhile, 735.00 parts of ion exchanged water and 16.00 parts of trisodium phosphate (dodecahydrate) were added to a vessel equipped with a high-speed stirrer homomixer (produced by Primix Corporation) and a temperature gauge, and the temperature was increased to 60° C. while stirring at 12,000 rpm. Here, an aqueous solution of calcium chloride, which was obtained by dissolving 9.00 parts of calcium chloride (dihydrate) in 65.00 parts of ion exchanged water, was placed in the vessel and stirred for 30 minutes at 12,000 rpm while maintaining a temperature of 60° C. The pH was then adjusted to 6.0 by adding 10% hydrochloric acid, thereby obtaining an aqueous medium containing a dispersion stabilizer.

The raw material-dispersed solution was then transferred to a vessel equipped with a stirrer and a temperature gauge, and the temperature was increased to 60° C. while stirring at 100 rpm. 8.00 parts of t-butyl peroxypivalate (Perbutyl PV, produced by NOF Corp.) was then added as a polymerization initiator, stirring was carried out for 5 minutes at 100 rpm while maintaining a temperature of 60° C., and the solution was then introduced into an aqueous medium being stirred at 12,000 rpm using the high-speed stirrer. A granulation solution was obtained by continuing the stirring for 20 minutes at 12,000 rpm using the high-speed stirrer while maintaining a temperature of 60° C.

The granulation solution was transferred to a reaction vessel equipped with a reflux condenser tube, a stirrer, a temperature gauge and a nitrogen inlet tube, and the temperature was increased to 70° C. while stirring at 150 rpm in a nitrogen atmosphere. A polymerization reaction was carried out for 10 hours while stirring at 150 rpm and maintaining a temperature of 70° C. A toner particle-dispersed solution was then obtained by removing the reflux condenser tube from the reaction vessel, increasing the temperature of the reaction liquid to 95° C., and removing toluene by stirring for 5 hours at 150 rpm while maintaining a temperature of 95° C. The thus obtained toner particle-dispersed solution was cooled to 20° C. while being stirred at 150 rpm, after which dilute hydrochloric acid was added under stirring until the pH reached 1.5, thereby dissolving the dispersion stabilizer. Solid content was filtered off, thoroughly washed with ion exchanged water and then vacuum dried for 24 hours at 40° C., thereby obtaining comparative toner particle 4. Comparative Toner 4 was then obtained by carrying out external addition in the same way as for Toner 1. Physical properties of the toner are shown in Table 5, and evaluation results are shown in Table 6.

Production Example of Comparative Toner 9

### Production of Comparative Resin A9 Particle-Dispersed Solution

Styrene: 300.0 parts
Stearyl acrylate: 700.0 parts
Dodecyl mercaptan: 6.0 parts
Decane diol diacrylic acid ester: 4.0 parts

A solution obtained by mixing and dissolving the materials listed above was dispersed and emulsified in a flask in a solution obtained by dissolving 20.0 parts of an anionic surfactant (Newrex Paste H produced by NOF Corp.) in 1300.0 parts of ion exchanged water. 200.0 parts of ion exchanged water having 20.0 parts of ammonium persulfate dissolved therein was introduced into the obtained emulsion over a period of 10 minutes while stirring, nitrogen purging was carried out, and the contents of the flask were then heated to 70° C. and emulsion polymerization was carried out for 6 hours. Next, a comparative resin A9 particle-dispersed solution was produced by cooling the reaction liquid to room temperature.

Production of Comparative Resin B7 Particle-Dispersed Solution
Styrene: 300.0 parts
Stearyl acrylate: 700.0 parts
Acrylic acid: 20.0 parts
Dodecyl mercaptan: 12.0 parts
Decane diol diacrylic acid ester: 4.0 parts

A solution obtained by mixing and dissolving the materials listed above was dispersed and emulsified in a flask in a solution obtained by dissolving 20.0 parts of an anionic surfactant (Newrex Paste H produced by NOF Corp.) in 1300.0 parts of ion exchanged water. 200.0 parts of ion exchanged water having 20.0 parts of ammonium persulfate dissolved therein was introduced into the obtained emulsion over a period of 10 minutes while stirring, nitrogen purging was carried out, and the contents of the flask were then heated to 70° C. and emulsion polymerization was carried out for 6 hours. Next, a comparative resin B7 particle-dispersed solution was produced by cooling the reaction liquid to room temperature. The comparative resin B7 was sampled from a part of the dispersed solution and analyzed. The comparative resin B7 had a Mw value of 16,800, an acid value of 18.0 mg KOH/g, a SP value of 20.2(J/cm³)^{0.5}, and a Tm value of 56° C.

Preparation of Colorant-Dispersed Solution

Phthalocyanine pigment: 250 parts
(PV FAST BLUE produced by Dainichiseika Color and Chemicals Mfg. Co., Ltd.)
Anionic surfactant: 20 parts
(Neogen RK produced by Dai-ichi Kogyo Seiyaku Co., Ltd.)
Ion exchanged water: 730 parts

A colorant-dispersed solution was obtained by mixing and dissolving the materials listed above and dispersing using a homogenizer (an Ultratarax produced by IKA).

Preparation of Wax Particle-Dispersed Solution

Polyethylene wax: 400 parts
(Polywax 725 produced by Toyo Petrolite Co., Ltd.)
Anionic surfactant: 20 parts
(Newrex R produced by NOF Corp.)
Ion exchanged water: 580 parts

A wax particle-dispersed solution was obtained by mixing and dissolving the materials listed above, dispersing using a homogenizer (an Ultratarax produced by IKA), and carrying out a dispersion treatment using a pressure-ejection homogenizer so as to disperse wax particles (polyethylene wax).

Production of Comparative Toner Particle 9

Comparative resin A9 particle-dispersed solution: 900.0 parts
Comparative resin B7 particle-dispersed solution: 225.0 parts
Colorant particle-dispersed solution: 100.0 parts
Wax particle-dispersed solution: 63.0 parts
Aluminum sulfate: 5.0 parts
(produced by Wako Pure Chemical Industries, Ltd.)
Ion exchanged water: 1000.0 parts

The materials listed above were placed in a round stainless steel flask, the pH was adjusted to 2.0, dispersion was carried out using a homogenizer (an Ultratarax T50 produced by IKA), and the contents of the flask were stirred and heated to a temperature of 64° C. using a heating oil bath. When observed with an optical microscope after maintaining a temperature of 61° C. for 3 hours, it was confirmed that aggregated particles having an average particle diameter of approximately 5.0 μm were formed. When observed with an optical microscope after continuing to heat and stir at a temperature of 61° C. for a further 4 hours, it was confirmed that aggregated particles having an average particle diameter of approximately 5.4 μm were formed. The pH of the aggregated particles was 2.5. An aqueous solution obtained by diluting sodium bicarbonate (produced by Wako Pure Chemical Industries, Ltd.) to a concentration of 0.5 mass % was added to adjust the pH to 7.2, and the contents of the flask were heated to 90° C. while continuing the stirring, and this temperature was maintained for 6 hours. Next, comparative toner particles 9 were obtained by filtering the reaction product, washing thoroughly with ion exchanged water and then drying using a vacuum dryer. The average particle diameter of the obtained comparative toner particles 9 was 5.5 μm. Comparative Toner 9 was then obtained by carrying out external addition in the same way as in Working Example 1. Physical properties of the toner are shown in Table 5, and evaluation results are shown in Table 6.

TABLE 5-1

| | Physical properties of toner | | | | | |
|---|---|---|---|---|---|---|
| | | | | Content of | Content of | Proportion of |
| | | Endothermic | | resin A in | resin B in | resin A and |
| | | peak | Endothermic | toner | toner | resin B |
| | Production | temperature | quantity | particle | particle | in binder resin |
| | method | [° C.] | [J/g] | [mass %] | [mass %] | [mass %] |
| Toner 1 | Suspension polymerization | 63.0 | 45 | 83.7 | 3.3 | 100.0 |
| Toner 2 | Suspension polymerization | 63.0 | 45 | 83.7 | 3.3 | 100.0 |
| Toner 3 | Suspension polymerization | 52.0 | 39 | 83.7 | 3.3 | 100.0 |
| Toner 4 | Suspension polymerization | 69.0 | 48 | 83.7 | 3.3 | 100.0 |
| Toner 5 | Suspension polymerization | 59.0 | 36 | 83.7 | 3.3 | 100.0 |
| Toner 6 | Suspension polymerization | 64.0 | 52 | 83.7 | 3.3 | 100.0 |
| Toner 7 | Suspension polymerization | 63.0 | 46 | 83.7 | 3.3 | 100.0 |
| Toner 8 | Suspension polymerization | 63.0 | 45 | 83.7 | 3.3 | 100.0 |
| Toner 9 | Suspension polymerization | 63.0 | 43 | 83.7 | 3.3 | 100.0 |
| Toner 10 | Suspension polymerization | 63.0 | 45 | 83.7 | 3.3 | 100.0 |
| Toner 11 | Suspension polymerization | 63.0 | 45 | 83.7 | 3.3 | 100.0 |
| Toner 12 | Suspension polymerization | 63.0 | 45 | 85.8 | 1.1 | 100.0 |
| Toner 13 | Suspension polymerization | 63.0 | 45 | 77.0 | 10.0 | 100.0 |
| Toner 14 | Suspension polymerization | 63.0 | 45 | 71.9 | 15.0 | 100.0 |
| Toner 15 | Suspension polymerization | 63.0 | 45 | 65.9 | 21.0 | 100.0 |
| Toner 16 | Suspension polymerization | 56.0 | 34 | 83.7 | 3.3 | 100.0 |
| Toner 17 | Suspension polymerization | 57.0 | 35 | 83.7 | 3.3 | 100.0 |
| Toner 18 | Suspension polymerization | 57.0 | 31 | 83.7 | 3.3 | 100.0 |
| Toner 19 | Suspension polymerization | 60.0 | 49 | 83.7 | 3.3 | 100.0 |
| Toner 20 | Suspension polymerization | 63.0 | 45 | 83.7 | 3.3 | 100.0 |
| Toner 21 | Suspension polymerization | 63.0 | 45 | 83.7 | 3.3 | 100.0 |
| Toner 22 | Suspension polymerization | 63.0 | 45 | 83.7 | 3.3 | 100.0 |
| Toner 23 | Suspension polymerization | 63.0 | 45 | 83.7 | 3.3 | 100.0 |
| Toner 24 | Suspension polymerization | 63.0 | 45 | 83.7 | 3.3 | 100.0 |
| Toner 25 | Suspension polymerization | 63.0 | 45 | 83.7 | 3.3 | 100.0 |
| Toner 26 | Suspension polymerization | 63.0 | 45 | 83.7 | 3.3 | 100.0 |
| Toner 27 | Suspension polymerization | 63.0 | 39 | 83.7 | 3.3 | 100.0 |
| Toner 28 | Suspension polymerization | 63.0 | 45 | 75.4 | 3.0 | 90.1 |
| Toner 29 | Suspension polymerization | 63.0 | 45 | 83.7 | 3.3 | 100.0 |
| Toner 30 | Suspension polymerization | 65.0 | 45 | 83.7 | 3.3 | 100.0 |
| Toner 31 | Pulverization | 64.0 | 45 | 82.2 | 3.2 | 100.0 |
| Toner 32 | Emulsion aggregation | 63.0 | 45 | 83.5 | 3.5 | 100.0 |
| Comparative toner 1 | Suspension polymerization | 62.0 | 45 | 83.7 | 3.3 | 96.2 |
| Comparative toner 2 | Suspension polymerization | 65.0 | 45 | 83.7 | 3.3 | 96.2 |
| Comparative toner 3 | Suspension polymerization | 60.0 | 48 | 78.0 | 7.8 | 90.9 |
| Comparative toner 4 | Suspension polymerization | 62.0 | 49 | 75.4 | 3.0 | 96.2 |
| Comparative toner 5 | Suspension polymerization | 63.0 | 45 | 83.7 | 3.3 | 96.2 |
| Comparative toner 6 | Suspension polymerization | 48.0 | 37 | 83.7 | 3.3 | 100.0 |
| Comparative toner 7 | Suspension polymerization | 64.0 | 67 | 83.6 | 3.3 | 100.0 |
| Comparative toner 8 | Suspension polymerization | 55.0 | 28 | 83.6 | 3.3 | 100.0 |
| Comparative toner 9 | Emulsion aggregation | 60.0 | 50 | 72.0 | 18.0 | 80.0 |

TABLE 5-2

| | Physical properties of resin A | | | | | | | | | |
|---|---|---|---|---|---|---|---|---|---|---|
| | Unit (a) | | | | | | | | | |
| | | | Number | | | | | | | |
| | | | of | | Unit (c) | | | | | |
| | | Content | carbon | SP | | Content | SP | | | |
| | | [mass %] | atoms | value | | [mass %] | value | SPc − | Acid | SP |
| | Type | (in resin A) | (n) | (Spa) | Type | (in resin A) | (SPc) | SPa | value | value |
| Toner 1 | BeA | 50.0 | 21 | 18.3 | MAN | 30.0 | 26.0 | 7.7 | 0.0 | 20.8 |
| Toner 2 | BeA | 50.0 | 21 | 18.3 | MAN | 30.0 | 26.0 | 7.7 | 0.0 | 20.8 |
| Toner 3 | StA | 50.0 | 17 | 18.8 | MAN | 30.0 | 26.0 | 7.1 | 0.0 | 20.9 |
| Toner 4 | MiA | 50.0 | 29 | 18.1 | MAN | 30.0 | 26.0 | 7.9 | 0.0 | 20.7 |
| Toner 5 | BeA | 42.1 | 21 | 18.3 | MAN | 29.9 | 26.0 | 7.7 | 0.0 | 21.2 |
| Toner 6 | BeA | 68.9 | 21 | 18.3 | MAN | 14.6 | 26.0 | 7.7 | 0.0 | 19.8 |
| Toner 7 | BeA | 50.0 | 21 | 18.3 | MAN | 30.0 | 26.0 | 7.7 | 0.0 | 20.8 |
| Toner 8 | BeA | 50.0 | 21 | 18.3 | MAN | 30.0 | 26.0 | 7.7 | 0.0 | 20.8 |
| Toner 9 | BeA | 50.0 | 21 | 18.3 | MAN | 30.0 | 26.0 | 7.7 | 0.0 | 20.8 |
| Toner 10 | BeA | 50.0 | 21 | 18.3 | MAN | 30.0 | 26.0 | 7.7 | 0.0 | 20.8 |
| Toner 11 | BeA | 50.0 | 21 | 18.3 | MAN | 30.0 | 26.0 | 7.7 | 0.0 | 20.8 |
| Toner 12 | BeA | 50.0 | 21 | 18.3 | MAN | 30.0 | 26.0 | 7.7 | 0.0 | 20.8 |
| Toner 13 | BeA | 49.9 | 21 | 18.3 | MAN | 30.1 | 26.0 | 7.7 | 0.0 | 20.8 |
| Toner 14 | BeA | 49.9 | 21 | 18.3 | MAN | 30.0 | 26.0 | 7.7 | 0.0 | 20.8 |
| Toner 15 | BeA | 49.9 | 21 | 18.3 | MAN | 30.1 | 26.0 | 7.7 | 0.0 | 20.8 |
| Toner 16 | BeA | 50.1 | 21 | 18.3 | MAN | 18.0 | 26.0 | 7.7 | 0.0 | 20.1 |
| Toner 17 | BeA | 50.1 | 21 | 18.3 | MAN | 22.0 | 26.0 | 7.7 | 0.0 | 20.3 |
| Toner 18 | BeA | 50.0 | 21 | 18.3 | VA | 30.0 | 21.6 | 3.3 | 0.0 | 19.5 |
| Toner 19 | BeA | 50.0 | 21 | 18.3 | AAD | 30.0 | 39.3 | 21.0 | 0.0 | 23.3 |
| Toner 20 | BeA | 50.0 | 21 | 18.3 | MAN | 30.0 | 26.0 | 7.7 | 0.0 | 20.8 |
| Toner 21 | BeA | 50.0 | 21 | 18.3 | MAN | 30.0 | 26.0 | 7.7 | 0.0 | 20.8 |
| Toner 22 | BeA | 50.0 | 21 | 18.3 | MAN | 30.0 | 26.0 | 7.7 | 0.0 | 20.8 |
| Toner 23 | BeA | 50.0 | 21 | 18.3 | MAN | 30.0 | 26.0 | 7.7 | 0.0 | 20.8 |
| Toner 24 | BeA | 50.0 | 21 | 18.3 | MAN | 30.0 | 26.0 | 7.7 | 0.0 | 20.8 |
| Toner 25 | BeA | 50.0 | 21 | 18.3 | MAN | 30.0 | 26.0 | 7.7 | 0.0 | 20.8 |
| Toner 26 | BeA | 50.0 | 21 | 18.3 | MAN | 30.0 | 26.0 | 7.7 | 0.0 | 20.8 |
| Toner 27 | BeA | 50.1 | 21 | 18.3 | MAN/ | 28.9/1.0 | 26.0/ | 7.7/ | 4.9 | 20.8 |
| | | | | | MAA | | 25.6 | 7.3 | | |
| Toner 28 | BeA | 50.0 | 21 | 18.3 | MAN | 30.0 | 26.0 | 7.7 | 0.0 | 20.8 |
| Toner 29 | BeA | 50.0 | 21 | 18.3 | MAN | 30.0 | 26.0 | 7.7 | 0.0 | 20.8 |
| Toner 30 | BeA | 50.0 | 21 | 18.3 | MAN | 30.0 | 26.0 | 7.7 | 0.0 | 20.8 |
| Toner 31 | BeA | 50.0 | 21 | 18.3 | MAN | 30.0 | 26.0 | 7.7 | 0.0 | 20.8 |
| Toner 32 | BeA | 50.0 | 21 | 18.3 | MAN | 30.0 | 26.0 | 7.7 | 0.0 | 20.8 |
| Comparative toner 1 | BeA | 50.0 | 21 | 18.3 | MAN | 30.0 | 26.0 | 7.7 | 0.0 | 20.8 |
| Comparative toner 2 | BeA | 50.0 | 21 | 18.3 | MAN | 30.0 | 26.0 | 7.7 | 0.0 | 20.8 |
| Comparative toner 3 | BeA | 70.0 | 21 | 18.3 | BMA | 30.0 | — | — | 0.0 | 18.5 |
| Comparative toner 4 | BeA | 65.7 | 21 | 18.3 | MAN | 21.5 | 26.0 | 7.7 | 0.0 | 20.1 |
| Comparative toner 5 | BeA | 50.0 | 21 | 18.3 | MAN | 30.0 | 26.0 | 7.7 | 0.0 | 20.8 |
| Comparative toner 6 | SeA | 50.0 | 15 | 17.7 | MAN | 30.0 | 26.0 | 8.3 | 0.0 | 20.5 |
| Comparative toner 7 | BeA | 82.0 | 21 | 18.3 | MAN | 15.0 | 26.0 | 7.7 | 0.0 | 19.4 |
| Comparative toner 8 | BeA | 35.1 | 21 | 18.3 | MAN | 30.0 | 26.0 | 7.7 | 0.0 | 21.1 |
| Comparative toner 9 | StA | 70.0 | 17 | 18.4 | — | — | — | — | 0.0 | 18.9 |

In the table, units for acid value are mg KOH/g, and units for SP value are

$${( {\text{J/cm}}^{3} )}^{0.5} .$$

TABLE 5-3

| | | | | | | Comparison of physical properties | | |
|---|---|---|---|---|---|---|---|---|
| | Physical properties of resin B | | | | | between resin A and resin B | | |
| | Unit (b) | | | | | Difference | | |
| | | | Number | | | in number | | |
| | | | of | | | of | Difference | Difference |
| | | Content | carbon | | | carbon | in acid | in SP |
| | | [mass %] | atoms | Acid | SP | atoms | value | value |
| | Type | (in resin B) | (m) | value | value | \|n − m\| | AvB − AvA | [SPA − SPB] |
| Toner 1 | BeA | 18.0 | 21 | 16.5 | 21.2 | 0 | 16.5 | 0.4 |
| Toner 2 | BeA | 18.0 | 21 | 16.5 | 22.3 | 0 | 16.5 | 1.5 |
| Toner 3 | StA | 18.0 | 17 | 16.5 | 21.2 | 0 | 16.5 | 0.3 |
| Toner 4 | MiA | 18.0 | 29 | 16.5 | 21.2 | 0 | 16.5 | 0.5 |
| Toner 5 | BeA | 18.0 | 21 | 16.5 | 21.2 | 0 | 16.5 | 0.0 |
| Toner 6 | BeA | 18.0 | 21 | 16.5 | 21.2 | 0 | 16.5 | 1.4 |
| Toner 7 | BeA | 5.2 | 21 | 16.5 | 21.4 | 0 | 16.5 | 0.6 |
| Toner 8 | BeA | 9.0 | 21 | 16.5 | 21.3 | 0 | 16.5 | 0.5 |
| Toner 9 | BeA | 28.0 | 21 | 16.5 | 20.9 | 0 | 16.5 | 0.1 |
| Toner 10 | LaA | 18.0 | 11 | 16.5 | 21.3 | 10 | 16.5 | 0.5 |
| Toner 11 | DcA | 18.0 | 9 | 16.5 | 21.3 | 12 | 16.5 | 0.5 |
| Toner 12 | BeA | 18.0 | 21 | 16.5 | 21.2 | 0 | 16.5 | 0.4 |
| Toner 13 | BeA | 18.0 | 21 | 16.5 | 21.2 | 0 | 16.5 | 0.4 |
| Toner 14 | BeA | 18.0 | 21 | 16.5 | 21.2 | 0 | 16.5 | 0.4 |
| Toner 15 | BeA | 18.0 | 21 | 16.5 | 21.2 | 0 | 16.5 | 0.4 |
| Toner 16 | BeA | 18.0 | 21 | 16.5 | 21.2 | 0 | 16.5 | 1.1 |
| Toner 17 | BeA | 18.0 | 21 | 16.5 | 21.2 | 0 | 16.5 | 0.9 |
| Toner 18 | BeA | 18.0 | 21 | 16.5 | 21.2 | 0 | 16.5 | 1.7 |
| Toner 19 | BeA | 18.0 | 21 | 16.5 | 21.2 | 0 | 16.5 | 2.1 |
| Toner 20 | BeA | 18.0 | 21 | 16.5 | 21.2 | 0 | 16.5 | 0.4 |
| Toner 21 | BeA | 18.0 | 21 | 16.5 | 21.2 | 0 | 16.5 | 0.4 |
| Toner 22 | BeA | 18.0 | 21 | 4.5 | 21.1 | 0 | 4.5 | 0.3 |
| Toner 23 | BeA | 18.0 | 21 | 5.2 | 21.1 | 0 | 5.2 | 0.3 |
| Toner 24 | BeA | 18.0 | 21 | 10.0 | 21.1 | 0 | 10.0 | 0.3 |
| Toner 25 | BeA | 18.0 | 21 | 25.0 | 21.3 | 0 | 25.0 | 0.5 |
| Toner 26 | BeA | 18.0 | 21 | 32.0 | 21.3 | 0 | 32.0 | 0.5 |
| Toner 27 | BeA | 18.0 | 21 | 16.5 | 21.2 | 0 | 11.6 | 0.4 |
| Toner 28 | BeA | 18.0 | 21 | 16.5 | 21.2 | 0 | 16.5 | 0.4 |
| Toner 29 | BeA | 18.0 | 21 | 16.5 | 20.6 | 0 | 16.5 | 0.2 |
| Toner 30 | BeA | 18.0 | 21 | 16.5 | 21.2 | 0 | 16.5 | 0.4 |
| Toner 31 | BeA | 18.0 | 21 | 16.5 | 21.2 | 0 | 16.5 | 0.4 |
| Toner 32 | BeA | 18.0 | 21 | 16.5 | 21.2 | 0 | 16.5 | 0.4 |
| Comparative toner 1 | — | — | — | 16.5 | 21.5 | — | 16.5 | 0.7 |
| Comparative toner 2 | — | — | — | 5.1 | 22.3 | — | 5.1 | 1.5 |
| Comparative toner 3 | — | — | — | 11.0 | 20.2 | — | 11.0 | 1.7 |
| Comparative toner 4 | — | — | — | 3.0 | 22.2 | — | 3.0 | 2.1 |
| Comparative toner 5 | BeA | 4.0 | 21 | 16.5 | 21.5 | 0 | 16.5 | 0.7 |
| Comparative toner 6 | CeA | 18.0 | 15 | 16.5 | 21.1 | 0 | 16.5 | 0.6 |
| Comparative toner 7 | BeA | 18.0 | 21 | 16.5 | 21.2 | 0 | 16.5 | 1.8 |
| Comparative toner 8 | BeA | 18.0 | 21 | 16.5 | 21.2 | 0 | 16.5 | 0.1 |
| Comparative toner 9 | StA | 68.6 | 17 | 18.0 | 20.2 | 0 | 18.0 | 1.3 |

Evaluations of the toner will now be explained.

Evaluation of Low-Temperature Fixability of Toner

The low-temperature fixability was evaluated using a modified laser beam printer (a LBP-7700C produced by Canon Inc.) as an image forming apparatus. The way in which the printer was modified was that the printer could be operated even with the fixing unit removed and the fixing temperature could be freely set. In addition, the paper used when outputting images was Fox River Bond (110 g/m²) produced by FOX RIVER, which is a rough paper. First, toner was removed from a cartridge, the cartridge was cleaned using an air blower, and the cartridge was filled with 300 g of a toner. Next, the cartridge was left for 48 hours in an environment at a temperature of 25° C. and a relative humidity of 40% (a N/N environment), then attached to the cyan station of the printer in this environment, and other stations in the printer were fitted with dummy cartridges. Evaluations were then carried out in a similar environment to that described above.

Next, using the image forming apparatus described above, from which the fixing unit had been removed, an unfixed image of an image pattern was outputted by transferring a 10 mm×10 mm square image to nine points which are intersections of lines dividing the long and short sides of the paper into four equal parts each. The toner laid on level on the paper was 0.80 mg/cm². Using the removed fixing unit, the processing speed was set to 250 mm/s, and fixed images were obtained at a variety of temperatures by fixing the unfixed images mentioned above at preset temperatures starting at 90° C. and increased by 5° C. each time. An obtained fixed image was rubbed back and forth five times using a lens-cleaning paper (Lenz Cleaning Paper “Dasper®” (Ozu Paper Co. Ltd.)) while applying a load of 50 g/cm². Image density was measured before and after rubbing, and the temperature at which the decrease in image density after rubbing was 20% or less of the image density before rubbing was taken to be the fixing onset temperature, and low-temperature fixability of toners was evaluated using this value. An evaluation of C or better was assessed as being good. The evaluation results are shown in Table 6.

A: Fixing onset temperature is 100° C. or lower
B: Fixing onset temperature is from 105° C. to 110° C.
C: Fixing onset temperature is from 115° C. to 120° C.
D: Fixing onset temperature is at least 125° C.

Evaluation of Toner Durability

Durability was evaluated using a commercially available Canon LBP-712Ci printer. A cartridge obtained by removing toner contained in a commercially available cartridge, cleaning the inner part of the cartridge with an air blower and then filling with 200 g of the toner mentioned above was used as an evaluation cartridge. After leaving the cartridge for 48 hours in an environment at a temperature of 25° C. and a relative humidity of 40%, the cartridge was attached to the cyan station and evaluated for durability. At this point, dummy cartridges were fitted to the other color stations.

In an environment having a temperature of 25° C. and a relative humidity of 40%, 20,000 horizontal line pattern images having a print percentage of 1% were continuously outputted using Canon Oce Red Label (80 g/m²). Next, solid images and half tone images were outputted, and the presence or absence of so-called development streaks in the circumferential direction caused by the toner melting and adhering to the control member was confirmed visually. Moreover, an evaluation of C or better was assessed as being good. The evaluation results are shown in Table 6.

A: No development streaks occurred
B: Development streaks occurred in from 1 to 2 locations
C: Development streaks occurred in from 3 to 4 locations
D: Development streaks occurred in at least 5 locations

Evaluation of Bending Resistance of Image at High Toner Laid-on Level

Bending resistance was evaluated using a commercially available Canon LBP-712Ci printer. A process cartridge filled with a toner was allowed to stand for 48 hours in an environment at a temperature of 25° C. and a relative humidity of 40%. Using this printer, two solid images measuring 50 mm×50 mm and having a toner laid-on level of 1.0 mg/cm² were formed in the center of a transfer paper at a temperature that was 10° C. higher than the fixing onset temperature mentioned above.

For one of these prints, the transfer paper was bent so that a valley fold line was a diagonal line across the solid image, and the transfer paper was then bent so that a mountain fold line formed a cross that divided the sides of the solid image into two equal parts. This bending procedure was carried out three times. The image was rubbed back and forth five times using a soft thin paper (“Dasper” produced by Ozu Co., Ltd.) while applying a load of 4.9 kPa. Image density was measured using the intersections of the four fold lines as a central point. For the other print, the bending procedure was not carried out and only the rubbing procedure was carried out, and image density was measured at the center part of the solid image. Image density was compared between the transfer paper that had been bent and the transfer paper that had not been bent, and the rate of decrease in image density was evaluated. An evaluation of C or better was assessed as being good.

A: Decrease in image density of less than 5.0%
B: Decrease in image density of not less than 5.0% and less than 8.0%
C: Decrease in image density of not less than 8.0% and less than 10.0%
D: Decrease in image density of at least 10.0%

Evaluation of Bending Resistance of Image at Low Toner Laid-on Level

Bending resistance was evaluated using a commercially available Canon LBP-712Ci printer. A process cartridge filled with a toner was allowed to stand for 48 hours in a N/N environment. Using this printer, two solid images measuring 50 mm×50 mm and having a toner laid-on level of 0.3 mg/cm² were formed in the center of a transfer paper at a temperature that was 10° C. higher than the fixing onset temperature mentioned above.

For one of these prints, the transfer paper was bent so that a valley fold line was a diagonal line across the solid image, and the transfer paper was then bent so that a mountain fold line formed a cross that divided the sides of the solid image into two equal parts. This bending procedure was carried out three times. The image was rubbed back and forth five times using a soft thin paper (“Dasper” produced by Ozu Co., Ltd.) while applying a load of 4.9 kPa. Image density was measured using the intersections of the four fold lines as a central point. For the other print, the bending procedure was not carried out and only the rubbing procedure was carried out, and image density was measured at the center part of the solid image. Image density was compared between the transfer paper that had been bent and the transfer paper that had not been bent, and the rate of decrease in image density was evaluated. An evaluation of C or better was assessed as being good.

A: Decrease in image density of less than 7.0%
B: Decrease in image density of not less than 7.0% and less than 9.0%
C: Decrease in image density of not less than 9.0% and less than 12.0%
D: Decrease in image density of at least 12.0%

Evaluation of Heat-Resistant Storage Stability of Toner

6 g of toner was placed in a 100 mL resin cup, which was left to stand for 10 days in an environment at a temperature of 50° C. and a relative humidity of 20%, after which the degree of agglomeration of the toner was measured in the manner described below. An apparatus obtained by connecting a digital display type vibrometer (Digi-Vibro Model 1332A produced by Showasokki Co., Ltd.) to a side surface of a “Powder Tester” vibrating table (produced by Hosokawa Micron Corp.) was used as the measurement apparatus. A sieve having an opening size of 38 μm (400 mesh), a sieve having an opening size of 75 μm (200 mesh) and a sieve having an opening size of 150 μm (100 mesh) were overlaid and set in that order from above on the vibrating table of the Powder Tester. Measurements were carried out using the following procedure in an environment at a temperature of 23° C. and a relative humidity of 60%.

(1) The amplitude of the vibrating table was adjusted in advance so that the amount of displacement of the digital display type vibrometer was 0.60 mm (peak-to-peak).

(2) The toner that had been allowed to stand for 10 days in the manner described above was allowed to stand for 24 hours in an environment at a temperature of 23° C. and a relative humidity of 60%, after which 5 g of this toner was weighed out and gently placed on the uppermost sieve, which had an opening size of 150 μm.

(3) After vibrating the sieve for 15 seconds, the mass of toner remaining on each sieve was measured, and the degree of agglomeration (%) was calculated using the formula below. The evaluation results are shown in Table 6. An evaluation of C or better was assessed as being good.

Degree of agglomeration (%)={(mass (g) of sample on sieve having opening size of 150 m)/5 (g)}×100+{(mass (g) of sample on sieve having opening size of 75 m)/5 (g)}×100×0.6+{(mass (g) of sample on sieve having opening size of 38 m)/5 (g)}×100×0.2

A: Degree of agglomeration is less than 20%
B: Degree of agglomeration is at least 20% and less than 25%
C: Degree of agglomeration is at least 25% and less than 30%
D: Degree of agglomeration is at least 30%

Evaluation results for each toner are shown in Table 6.

TABLE 6

| | | | | | Bending | | Bending | | | |
|---|---|---|---|---|---|---|---|---|---|---|
| | | | | | resistance | | resistance | | | |
| | Low-temperature | | | | (at high laid-on | | (at low laid-on | | Heat-resistant | |
| | fixability | | | | level) | | level) | | storage stability | |
| | | Lowest | Durability | | | Change | | Change | | Degree |
| | | fixing | | Development | | in | | in | | of |
| | | temperature | | streaks | | density | | density | | agglomeration |
| | Eva. | [° C.] | Eva. | [number] | Eva. | [%] | Eva. | [%] | Eva. | [%] |
| Toner 1 | A | 95 | A | 0 | A | 3.4 | A | 5.8 | A | 18 |
| Toner 2 | A | 95 | A | 0 | A | 3.9 | A | 5.7 | A | 18 |
| Toner 3 | A | 90 | B | 1 | A | 3.2 | A | 5.8 | C | 28 |
| Toner 4 | B | 110 | A | 0 | A | 3.4 | A | 5.7 | A | 15 |
| Toner 5 | C | 115 | B | 1 | A | 2.6 | A | 4.1 | B | 24 |
| Toner 6 | A | 90 | C | 0 | C | 8.5 | C | 9.2 | A | 19 |
| Toner 7 | A | 100 | C | 3 | C | 8.3 | B | 9.3 | A | 17 |
| Toner 8 | A | 95 | B | 2 | B | 6.7 | A | 6.8 | A | 17 |
| Toner 9 | A | 90 | C | 4 | C | 8.8 | C | 7.9 | B | 21 |
| Toner 10 | A | 95 | B | 2 | B | 5.2 | B | 7.7 | A | 19 |
| Toner 11 | A | 90 | C | 3 | C | 8.1 | B | 8.9 | B | 20 |
| Toner 12 | A | 95 | C | 1 | C | 9.2 | B | 9.0 | B | 21 |
| Toner 13 | B | 105 | A | 0 | A | 2.5 | A | 4.7 | A | 17 |
| Toner 14 | B | 110 | A | 0 | A | 2.1 | A | 4.3 | A | 16 |
| Toner 15 | C | 115 | A | 0 | A | 1.6 | A | 4.1 | A | 15 |
| Toner 16 | B | 105 | A | 0 | A | 3.1 | A | 6.7 | C | 25 |
| Toner 17 | B | 105 | A | 0 | A | 2.9 | A | 6.1 | B | 21 |
| Toner 18 | C | 115 | B | 2 | B | 7.8 | B | 7.0 | C | 25 |
| Toner 19 | A | 95 | C | 3 | C | 9.5 | B | 7.3 | A | 19 |
| Toner 20 | A | 90 | B | 2 | B | 5.4 | B | 5.6 | B | 22 |
| Toner 21 | A | 95 | A | 0 | A | 4.8 | A | 6.2 | A | 17 |
| Toner 22 | A | 95 | C | 3 | C | 8.0 | C | 10.7 | A | 19 |
| Toner 23 | A | 95 | B | 2 | B | 6.4 | B | 8.2 | A | 18 |
| Toner 24 | A | 95 | B | 1 | A | 3.9 | A | 7.1 | A | 19 |
| Toner 25 | A | 95 | B | 2 | B | 6.1 | A | 3.2 | A | 18 |
| Toner 26 | A | 95 | C | 3 | B | 8.0 | B | 7.1 | B | 24 |
| Toner 27 | B | 110 | B | 2 | C | 8.1 | B | 7.1 | C | 26 |
| Toner 28 | B | 105 | A | 0 | A | 3.5 | A | 5.6 | A | 18 |
| Toner 29 | A | 95 | B | 2 | B | 7.1 | B | 7.3 | A | 18 |
| Toner 30 | A | 100 | A | 0 | A | 4.1 | A | 5.3 | A | 19 |
| Toner 31 | B | 110 | B | 2 | C | 8.3 | C | 9.6 | A | 18 |
| Toner 32 | B | 110 | C | 3 | C | 8.9 | B | 8.9 | A | 19 |
| Comparative toner 1 | B | 110 | D | 5 | D | 10.5 | B | 12.0 | A | 17 |
| Comparative toner 2 | A | 100 | D | 5 | D | 9.8 | C | 12.0 | A | 18 |
| Comparative toner 3 | A | 95 | D | 5 | C | 9.2 | C | 11.5 | C | 25 |
| Comparative toner 4 | B | 110 | A | 0 | A | 4.5 | D | 13.3 | A | 18 |
| Comparative toner 5 | A | 95 | C | 4 | D | 10.0 | D | 12.2 | A | 18 |
| Comparative toner 6 | A | 90 | B | 2 | A | 4.3 | A | 5.1 | D | 32 |
| Comparative toner 7 | A | 90 | D | 5 | D | 12.5 | C | 12.1 | A | 17 |
| Comparative toner 8 | D | 125 | A | 0 | A | 2.7 | A | 3.3 | C | 26 |
| Comparative toner 9 | A | 95 | D | 6 | D | 12.1 | D | 12.2 | D | 31 |

In the table, abbreviations used in the tables are as follows.

### Eva.: Evaluation

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-068154, filed Apr. 14, 2021, and Japanese Patent Application No. 2022-041315, filed Mar. 16, 2022, which are hereby incorporated by reference herein in their entirety.

What is claimed is:

1. A toner comprising a toner particle comprising a binder resin, wherein
the binder resin comprises a resin A and a resin B,
in a differential scanning calorimetric measurement using the toner as a sample, an endothermic peak derived from the resin A is observed, a peak top temperature of the largest endothermic peak derived from the resin A is present within a temperature range of 50.0 to 90.0° C. and an endothermic amount of the endothermic peak derived from the resin A is 30 to 70 J/g per 1 g of the toner,
a ratio of content of the resin A in the toner particle is 60.0 to 90.0 mass %,
the resin A comprises 40.0 to 70.0 mass % of a monomer unit (a) represented by formula (1) below, and
the resin B comprises 5.0 to 30.0 mass % of a monomer unit (b) represented by formula (2) below: 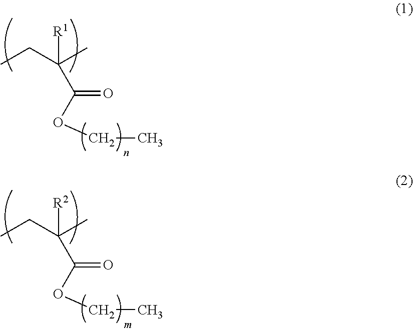
in formula (1), R¹ denotes a hydrogen atom or a methyl group, and n denotes an integer of 15 to 31 and in formula (2), R² denotes a hydrogen atom or a methyl group, and m denotes an integer from 9 to 31.

2. The toner according to claim 1, wherein an absolute value of a difference between a value of n in the formula (1) and a value of m in the formula (2) (|n−m|) is 10 or less.

3. The toner according to claim 1, wherein a ratio of content of the resin B in the toner particle is 1.0 to 20.0 mass %.

4. The toner according to claim 1, wherein the resin A comprises a monomer unit (c) different from the monomer unit (a),
when an SP value of the monomer unit (a) is denoted by SPa and an SP value of the monomer unit (c) is denoted by SPc, then formula (3) below is satisfied, and
a ratio of content of the monomer unit (c) in the resin A is 20.0 mass % or more:
3.0≤(SPc−SPa)≤25.0 (3).

5. The toner according to claim 4, wherein the monomer unit (c) is represented by formula (4) below: 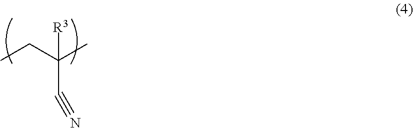
in formula (4), R³ denotes a hydrogen atom or a methyl group.

6. The toner according to claim 1, wherein a weight average molecular weight MwB of tetrahydrofuran-soluble matter in the resin B, as measured by gel permeation chromatography, is 10,000 to 20,000.

7. The toner according to claim 1, wherein an acid value AvB of the resin B is 5.0 to 30.0 mg KOH/g, and
a difference between an acid value AvA of the resin A and an acid value AvB (AvB−AvA) is 5.0 mg KOH/g or more.

8. The toner according to claim 1, wherein an acid value AvA of the resin A is 5.0 mg KOH/g or less.

9. The toner according to claim 1, wherein when an SP value of the resin A is denoted by SPA (J/cm³)^{0.5} and an SP value of the resin B is denoted by SPB (J/cm³)^{0.5}, then an absolute value of a difference between SPA and SPB satisfies formula (5) below:
0.2≤|SPA−SPB|≤2.0 (5).

10. The toner according to claim 1, wherein a glass transition temperature TgB of the resin B is 30.0 to 90.0° C.

11. The toner according to claim 1, wherein the resin B comprises 5.0 to 25.0 mass % of the monomer unit (b) represented by the formula (2) above.

12. The toner according to claim 1, wherein a total content of the resin A and the resin B in the binder resin is 80.0 mass % or more.

13. The toner according to claim 1, wherein the resin A is a crystalline resin, and
the resin B is an amorphous resin.

14. A method for producing a toner comprising a toner particle comprising a binder resin, wherein
the binder resin comprises a resin A and a resin B,
the resin A comprises 40.0 to 70.0 mass % of a monomer unit (a) represented by formula (1) below, and
the resin B comprises 5.0 to 30.0 mass % of a monomer unit (b) represented by formula (2) below,
the production method comprising:
a step for producing a polymerizable monomer composition comprising the resin B and a polymerizable monomer able to form the resin A, and
a step for polymerizing the polymerizable monomer comprised in the polymerizable monomer composition to obtain the toner particle: 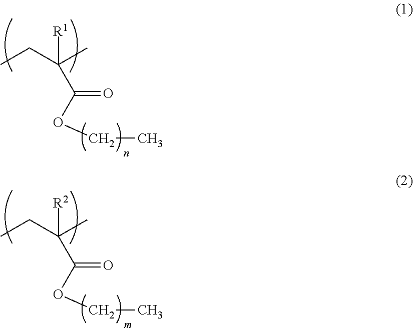
in formula (1), R¹ denotes a hydrogen atom or a methyl group, and n denotes an integer of 15 to 31, and in formula (2), R² denotes a hydrogen atom or a methyl group, and m denotes an integer of 9 to 31.
